(19) United States
(12) Patent Application Publication
(10) Pub. No.: US 2025/0036250 A1
(43) Pub. Date: Jan. 30, 2025

(54) METHODS AND SYSTEMS INCLUDING A GRAPH-BASED USER INTERFACE THAT DISPLAYS, AND THAT PROVIDES FOR GENERATING AND EDITING, CLOUD-INFRASTRUCTURE-SPECIFICATION-AND-CONFIGURATION FILES

(71) Applicant: VMWARE LLC, Palo Alto, CA (US)

(72) Inventors: PRIYANK AGARWAL, Bangalore (IN); NITIN RAMACHANDRA, Bangalore (IN); VALENTINA LEONIDOVNA REUTOVA, London (GB); PRAVEEN KUMAR, Bangalore (IN); VIJAY CHAUHAN, Bangalore (IN)

(21) Appl. No.: 18/382,063

(22) Filed: Oct. 20, 2023

(30) Foreign Application Priority Data
Jul. 26, 2023 (IN) 202341050489

(51) Int. Cl. G06F 3/0481; G06F 3/04845; G06F 9/451; G06T 11/00

(52) U.S. Cl. CPC G06F 3/0481; G06F 3/04845; G06F 9/451; G06T 11/001; G06T 2200/24

(57) ABSTRACT

The current document is directed to an infrastructure-as-code (“IaC”) cloud-infrastructure-management service or system including a graph-based user interface that displays, and that provides for generating and editing, cloud-infrastructure-specification-and-configuration files. The IaC cloud-infrastructure-management service or system processes a set of infrastructure-specification-and-configuration files to identify specified resources and relationships between resources. The resources and relationships are then stored as a graph, along with various indices that can be used for quickly searching the graph for relationships and resources of interest. A graph-based user interface allows users to view portions of the graph, navigate through the graph, search for particular resources and relationships, and edit the infrastructure-specification-and-configuration files.

### RELATED APPLICATIONS

Benefit is claimed under 35 U.S.C. 119 (a)-(d) to Foreign application No. 202341050489 filed in India entitled “METHODS AND SYSTEMS INCLUDING A GRAPH-BASED USER INTERFACE THAT DISPLAYS, AND THAT PROVIDES FOR GENERATING AND EDITING, CLOUD-INFRASTRUCTURE-SPECIFICATION-AND-CONFIGURATION FILES”, on Jul. 26, 2023, by VMware, Inc., which is herein incorporated in its entirety by reference for all purposes.

### TECHNICAL FIELD

The current document is directed to distributed-computer-systems and, in particular, to an infrastructure-as-code (“IaC”) cloud-infrastructure-management service or system including a graph-based user interface that displays, and that provides for generating and editing, cloud-infrastructure-specification-and-configuration files.

### BACKGROUND

During the past seven decades, electronic computing has evolved from primitive, vacuum-tube-based computer systems, initially developed during the 1940s, to modern electronic computing systems, including distributed cloud-computing systems, in which large numbers of multiprocessor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. The advent of distributed computer systems has provided a computational platform for increasingly complex distributed applications, including distributed service-oriented applications. Distributed applications, including distributed service-oriented applications and distributed microservices-based applications, provide many advantages, including efficient scaling to respond to changes in workload, efficient functionality compartmentalization that, in turn, provides development and management efficiencies, flexible response to system component failures, straightforward incorporation of existing functionalities, and straightforward expansion of functionalities and interfaces with minimal interdependencies between different types of distributed-application instances. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems and applications have, in turn, become increasingly complex, involving greater computational overheads and significant inefficiencies and deficiencies. In fact, many desired management-and-administration functionalities are becoming sufficiently complex to render traditional approaches to the design and implementation of automated and semi-automated management and administration subsystems impractical, from a time and cost standpoint. Therefore, designers and developers of distributed computer systems and applications continue to seek new approaches to implementing automated and semi-automated management-and-administration facilities and functionalities.

### SUMMARY

The current document is directed to an infrastructure-as-code (“IaC”) cloud-infrastructure-management service or system including a graph-based user interface that displays, and that provides for generating and editing, cloud-infrastructure-specification-and-configuration files. The IaC cloud-infrastructure-management service or system processes a set of infrastructure-specification-and-configuration files to identify specified resources and relationships between resources. The resources and relationships are then stored as a graph, along with various indices that can be used for quickly searching the graph for relationships and resources of interest. A graph-based user interface allows users to view portions of the graph, navigate through the graph, search for particular resources and relationships, and edit the infrastructure-specification-and-configuration files.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates a number of different cloud-computing facilities that provide computational infrastructure to an organization for supporting the organization's distributed applications and services.

FIG. 9 illustrates a universal-management-interface provided by the currently disclosed IaC cloud-infrastructure-management service.

FIG. 10 illustrates the architecture of the currently disclosed IaC cloud-infrastructure-management service.

FIG. 11 illustrates the cloud-management interface provided by the currently disclosed IaC cloud-infrastructure-management service.

FIG. 12 illustrates components of a GraphQL API interface.

FIGS. 13A-14E illustrate an example schema, an extension to that example schema, and queries, a mutation, and a subscription to illustrate the GraphQL data query language.

FIG. 15 illustrates a stitching process.

FIGS. 16A-D illustrate the YAML Ain′t Markup Language (“YAML”) data serialization language.

FIG. 17 illustrates certain features provided by the Jinja template engine that are used, in addition to YAML, for representing infrastructure in SLS documents.

FIGS. 18A-C illustrate a structured labor state (“SLS”) data file and credential file as well as the output from an Idem describe command.

FIG. 19 illustrates a fundamental control loop involving the Idem service.

FIG. 20 illustrates one implementation of the Idem service.

FIG. 21 illustrates the currently disclosed graph-based user interface (“GBUI”).

FIG. 22 illustrates an initial step in processing a set of SLS data files for representation as a graph by the currently disclosed GBUI.

FIG. 23 illustrates a concept underlying a second step in processing a set of SLS data files for representation as a graph by the currently disclosed GBUI.

FIG. 24 illustrates the second step in processing a set of SLS data files for representation as a graph by the currently disclosed GBUI.

FIG. 25 illustrates the third step in processing a set of SLS data files for representation as a graph by the currently disclosed GBUI.

FIG. 26 illustrates various different ways a resource object extracted from a capsule can be added to the information stored by the GBUI for representation of the information contained in a set of SLS data files by a graph.

FIG. 27 illustrates graph compaction.

FIG. 28 illustrates the architecture of one implementation of the GBUI.

FIGS. 29A-S illustrate operation of one implementation of the currently disclosed GBUI.

### DETAILED DESCRIPTION

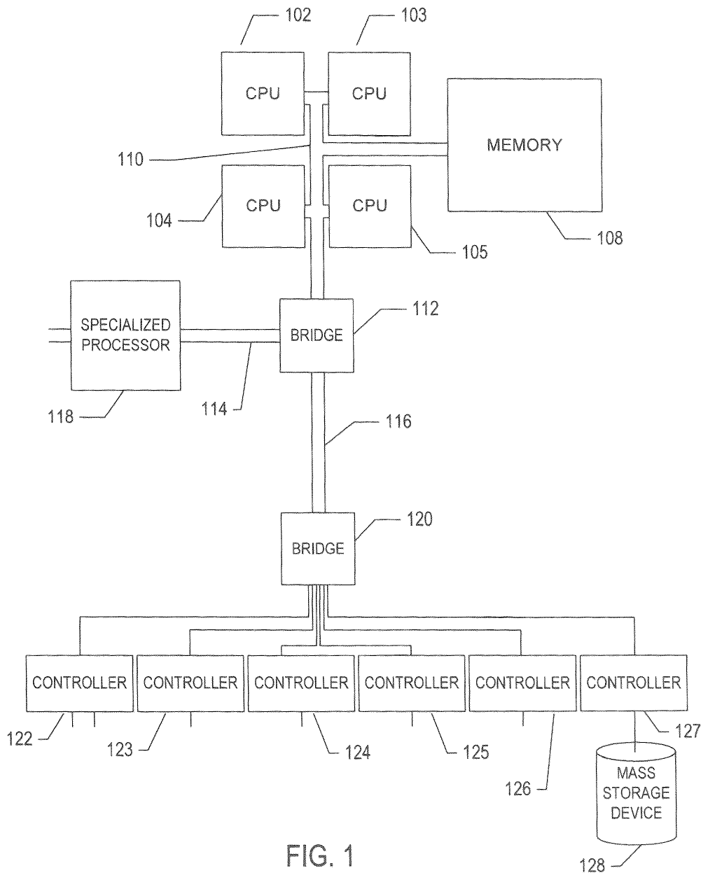

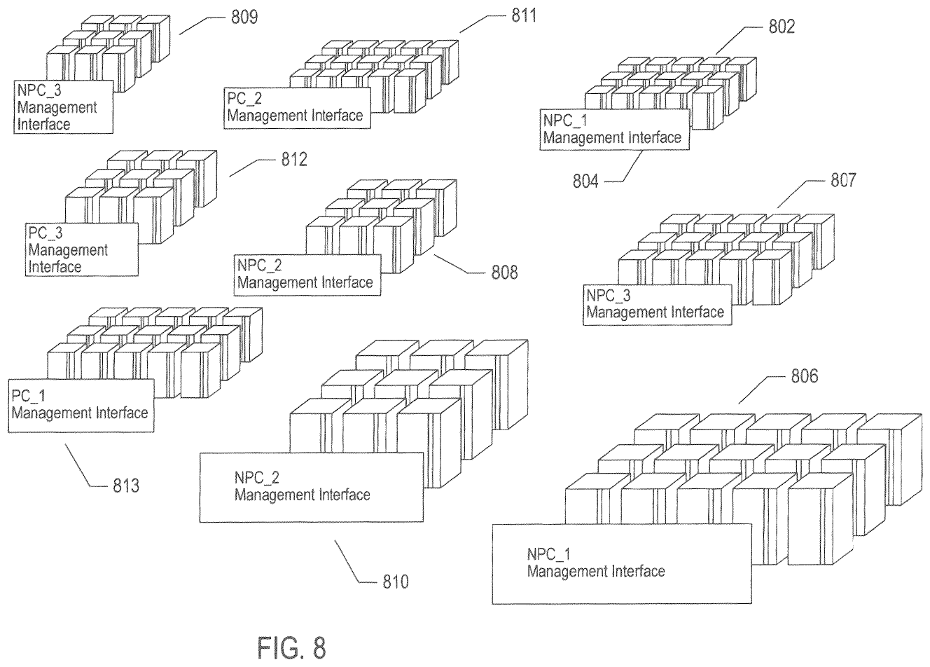

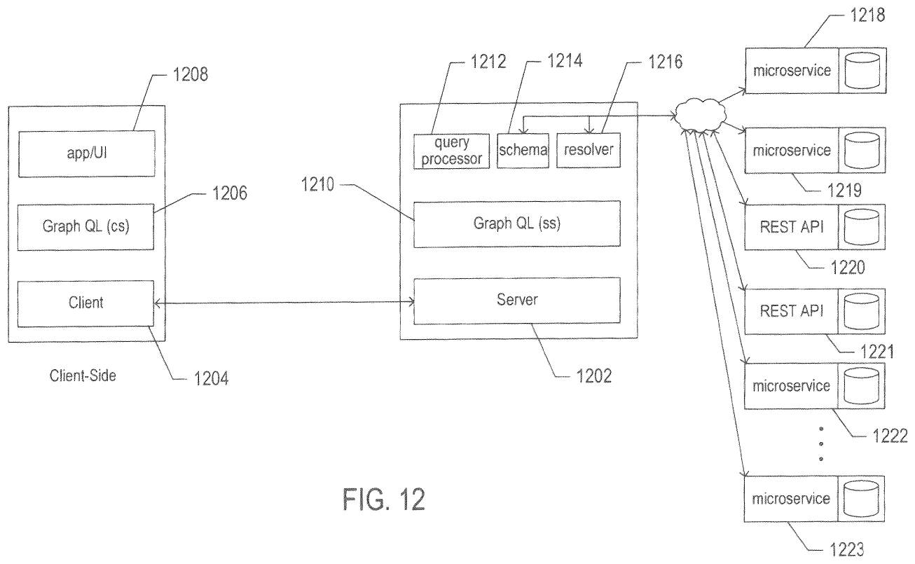

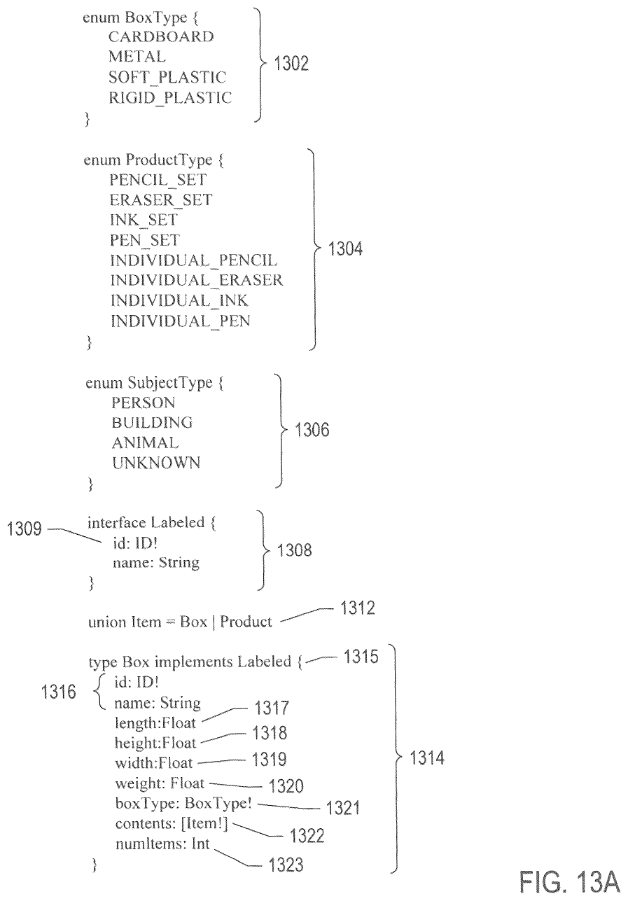

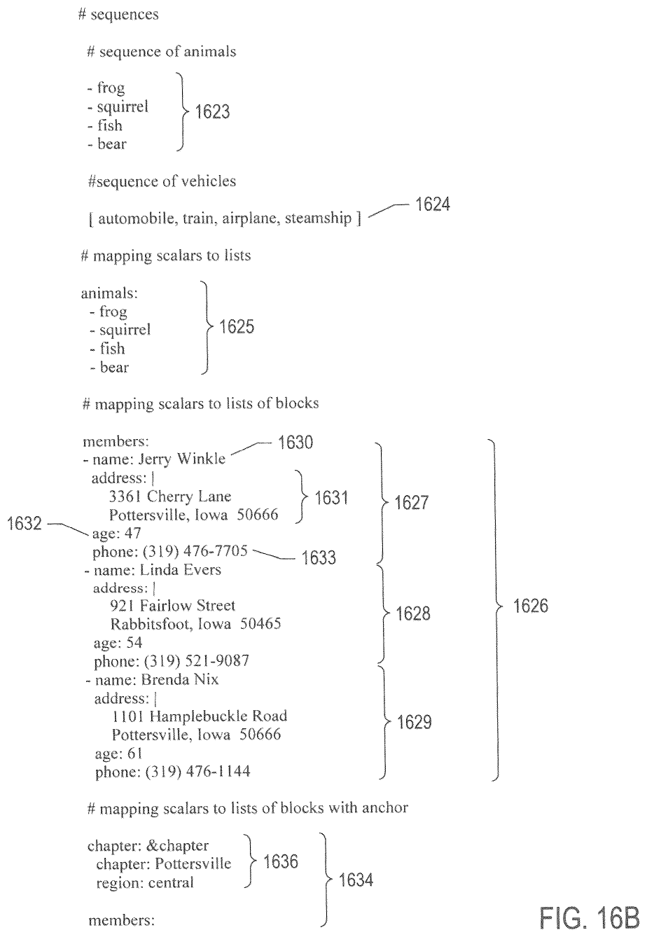

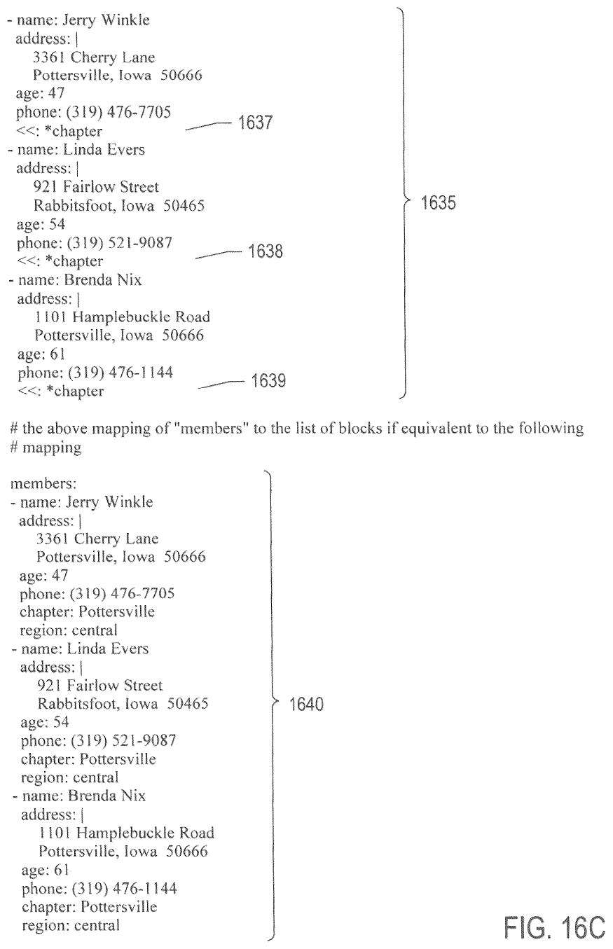

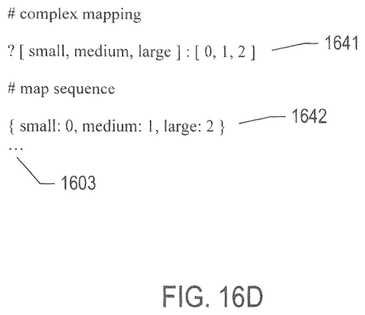

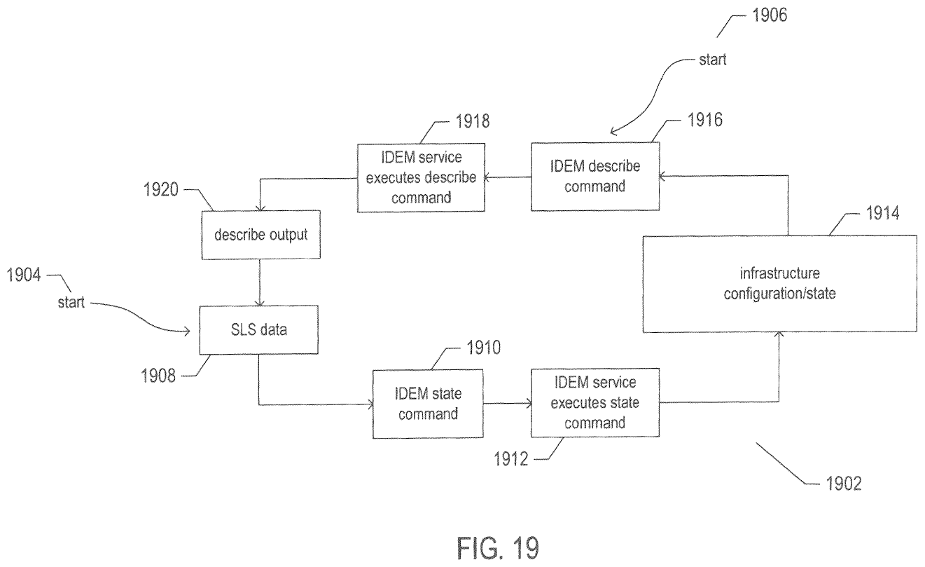

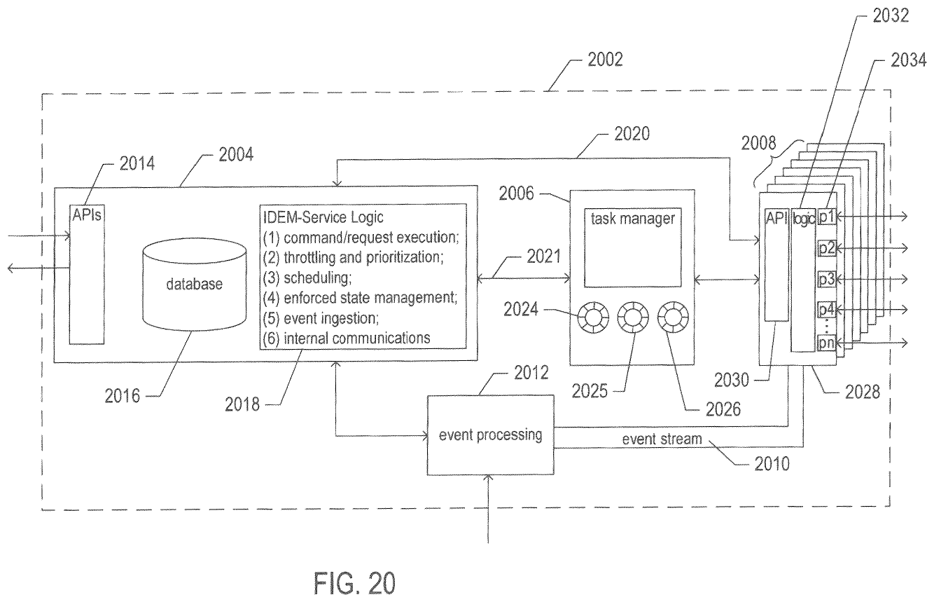

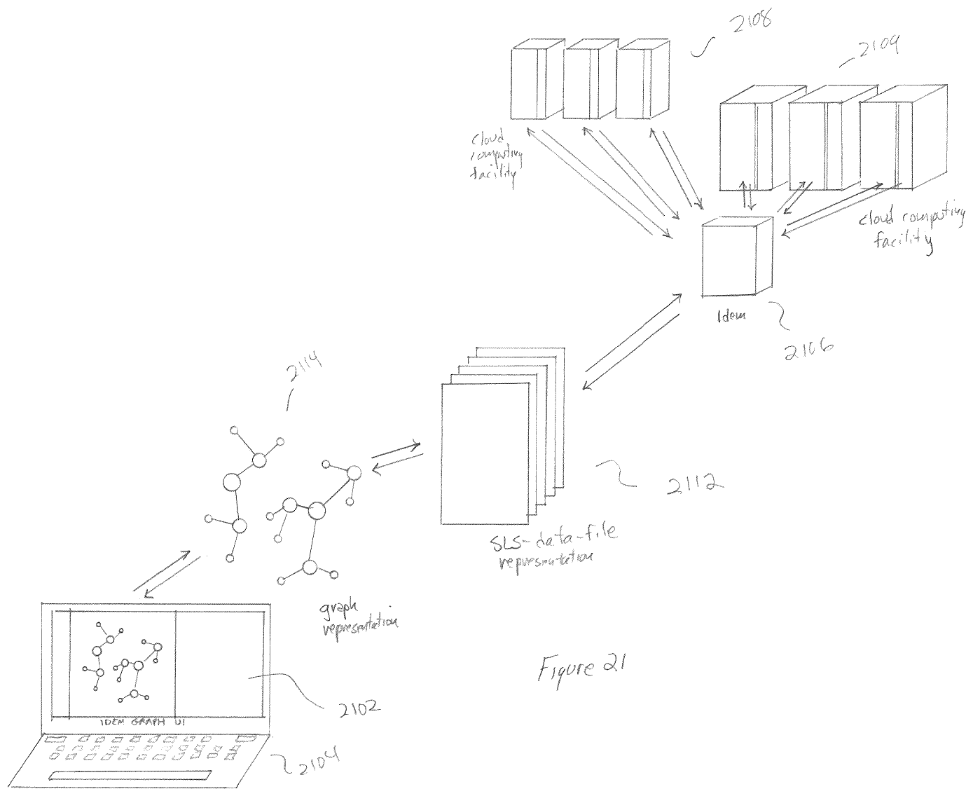

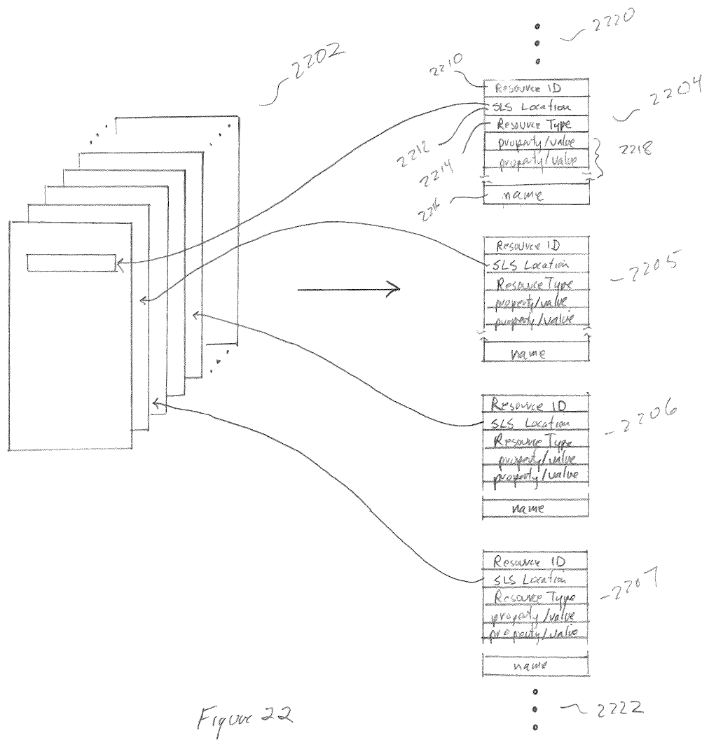

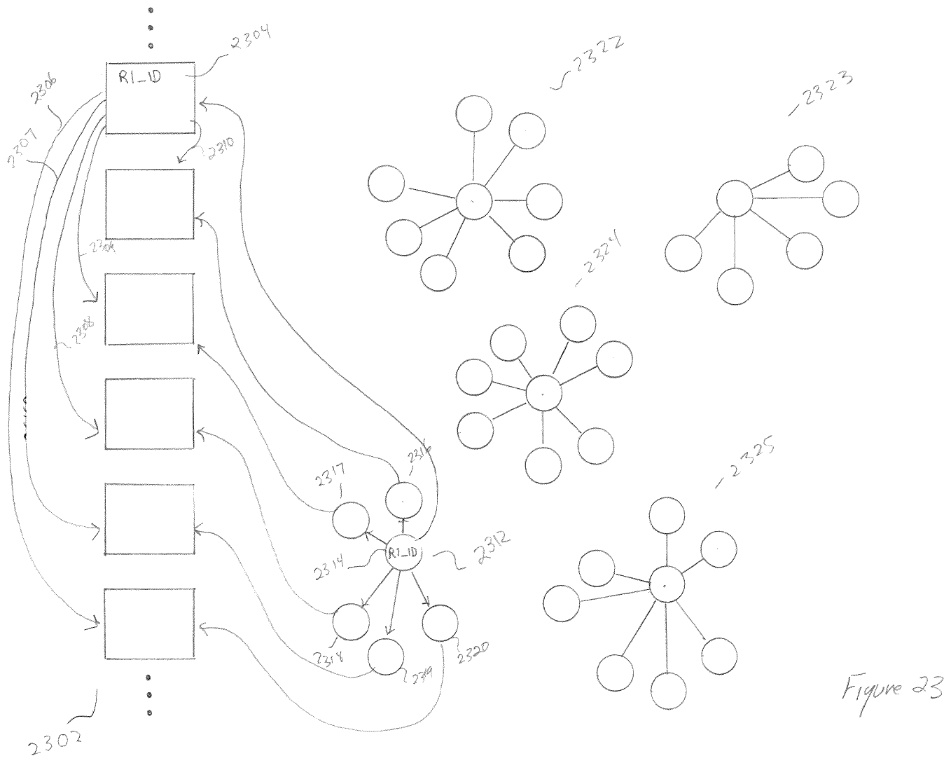

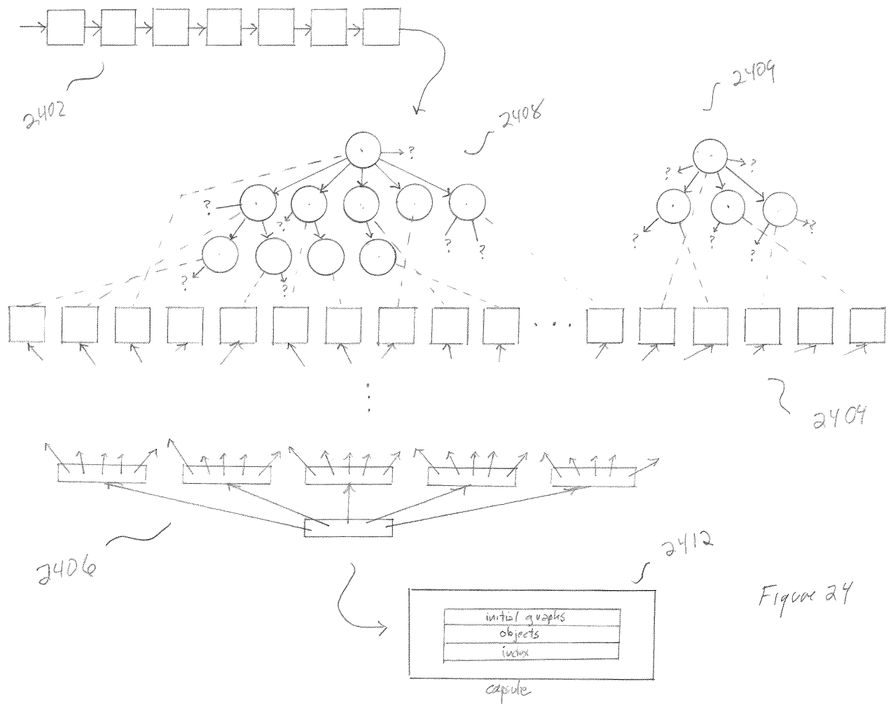

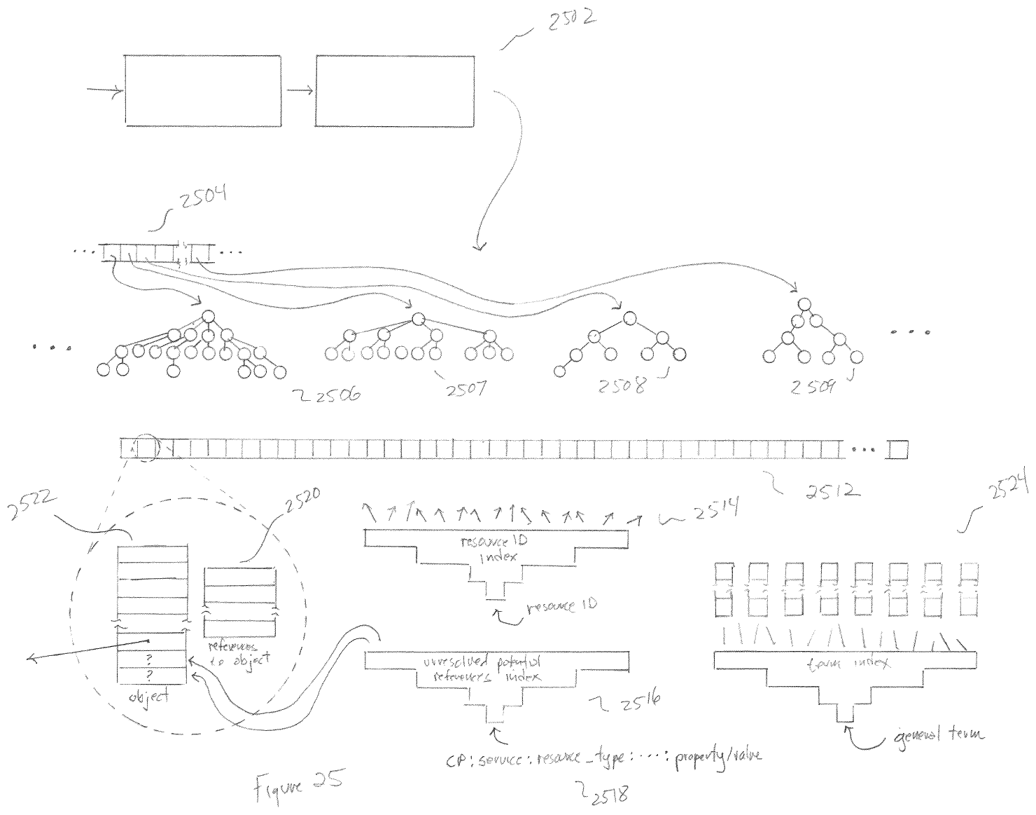

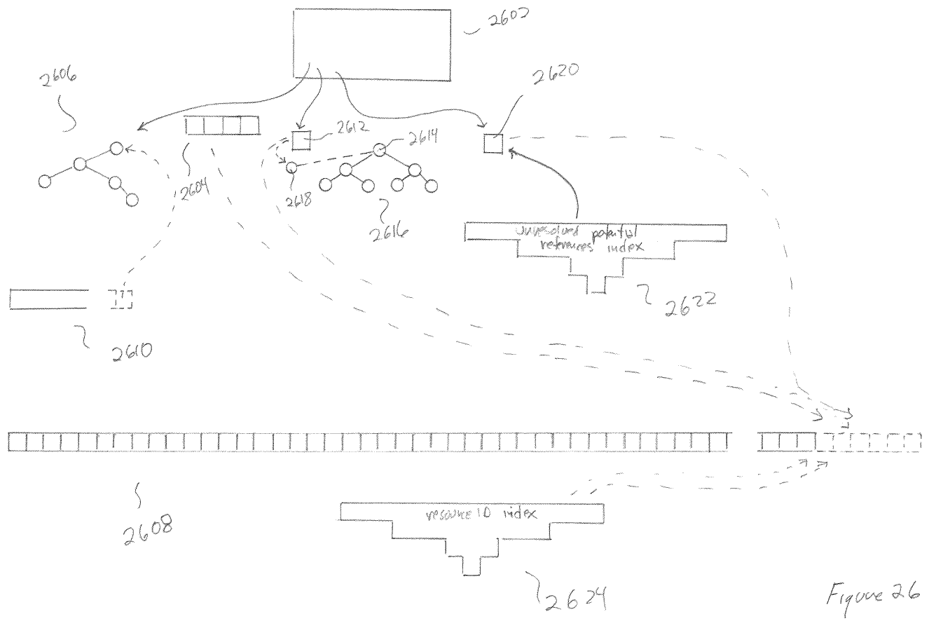

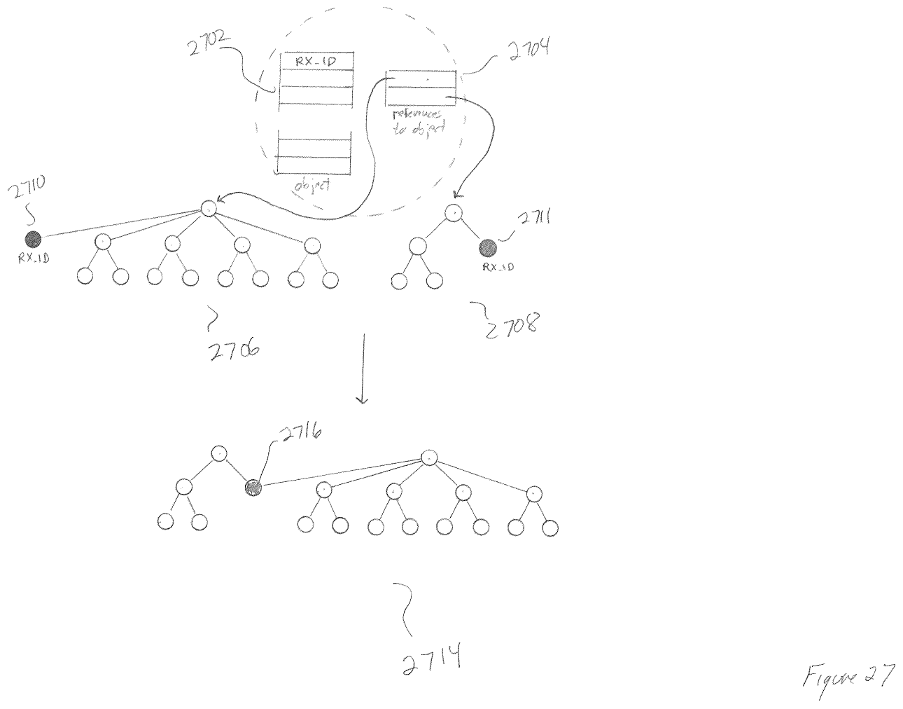

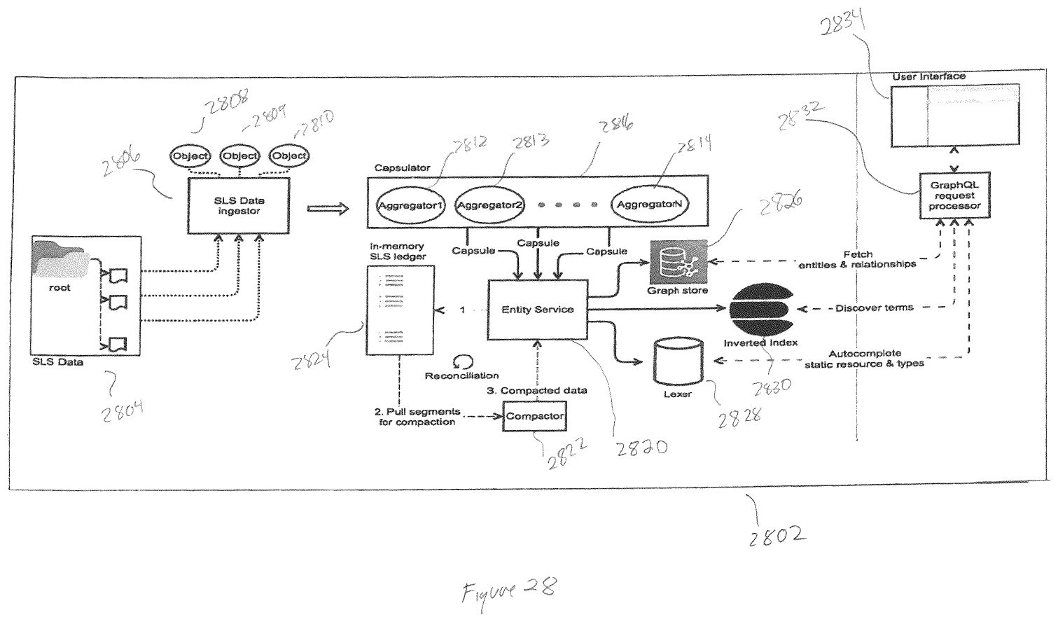

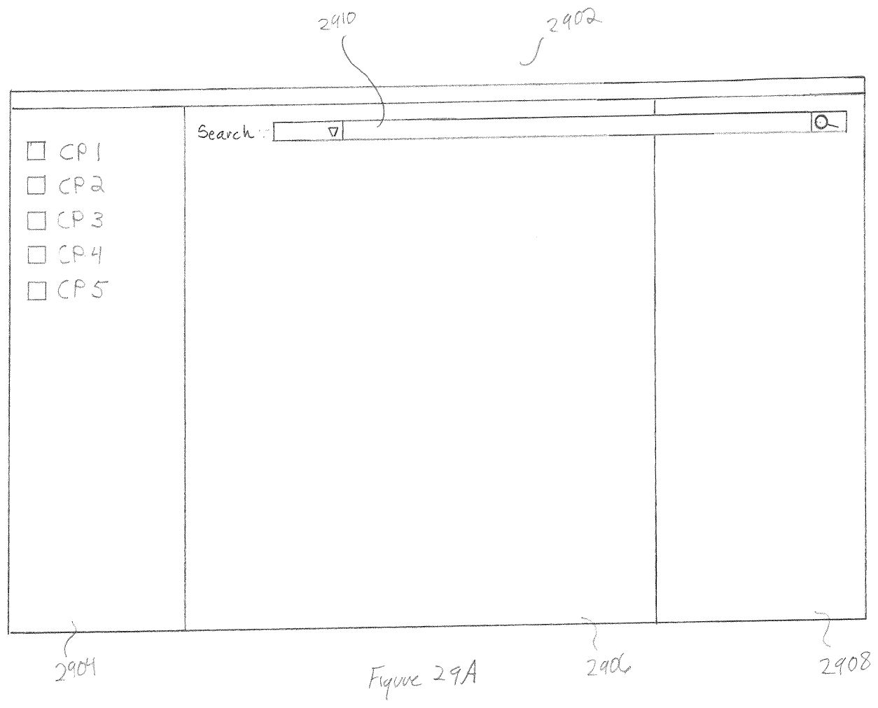

The current document is directed to an infrastructure-as-code (“IaC”) cloud-infrastructure-management service or system including a graph-based user interface that displays, and that provides for generating and editing, cloud-infrastructure-specification-and-configuration files. In a first subsection, below, a detailed description of computer hardware, complex computational systems, and virtualization is provided with reference to FIGS. 1-7. In a second subsection, an overview of an IaC cloud-infrastructure-management service is provided, with reference to FIGS. 8-11. A third subsection provides an overview of the GraphQL API interface with reference to FIGS. 12-15. A fourth subsection provides an overview of YAML, JINJA, and SLS documents with reference to FIGS. 16-18C. A fifth subsection introduces an Infrastructure-as-Code cloud-infrastructure-management service or system, with reference to FIGS. 19-20, in which the currently disclosed graph-based user interface is included. The currently disclosed methods and systems are discussed in a sixth subsection with reference to FIGS. 21-29S.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

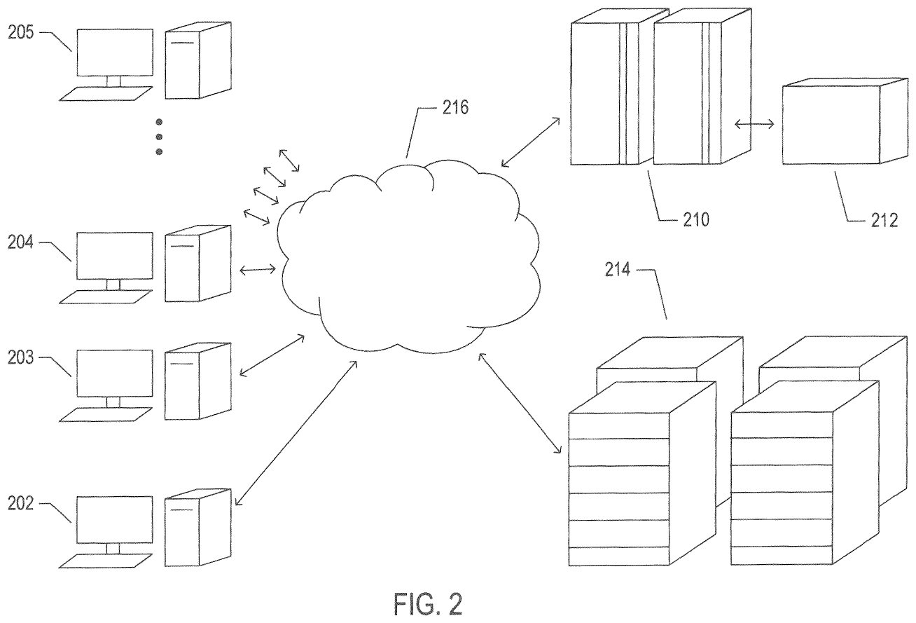

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

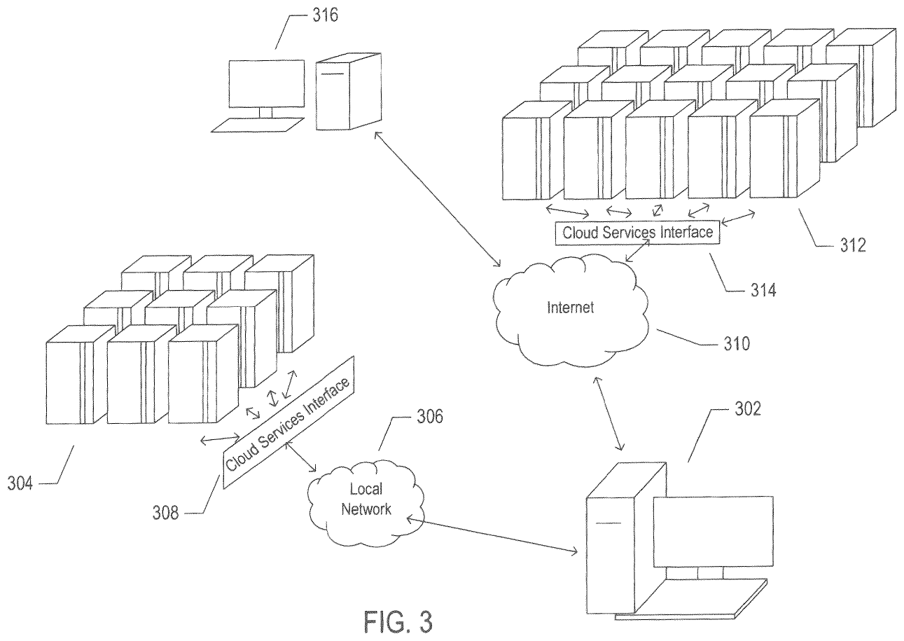

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

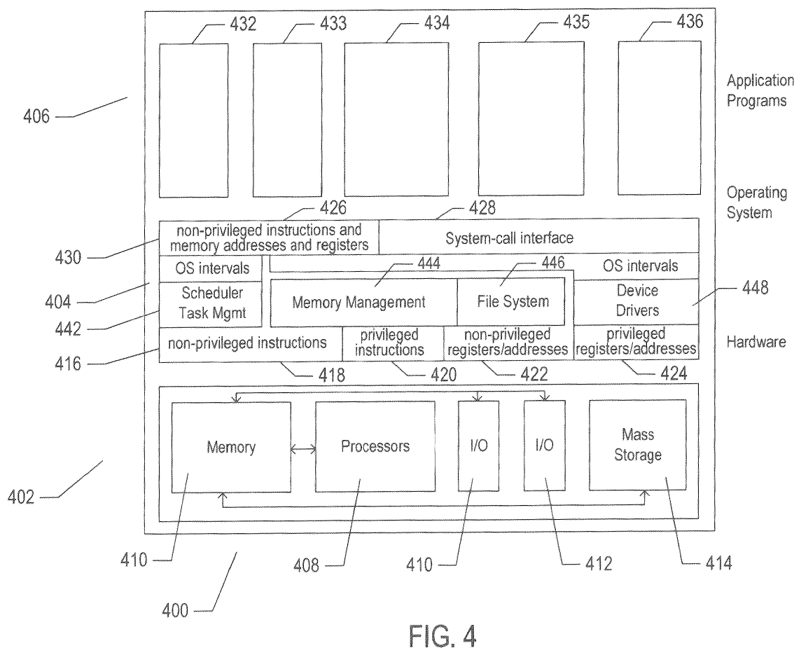

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

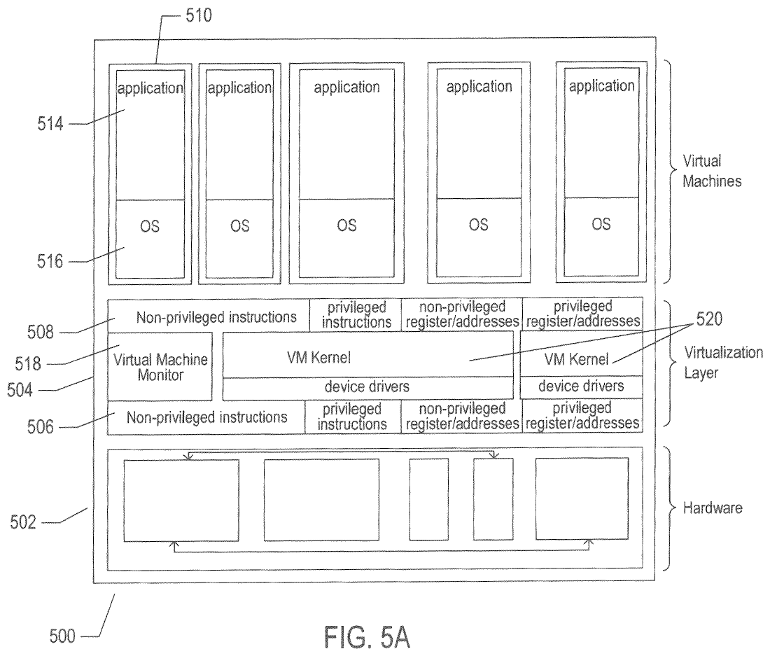

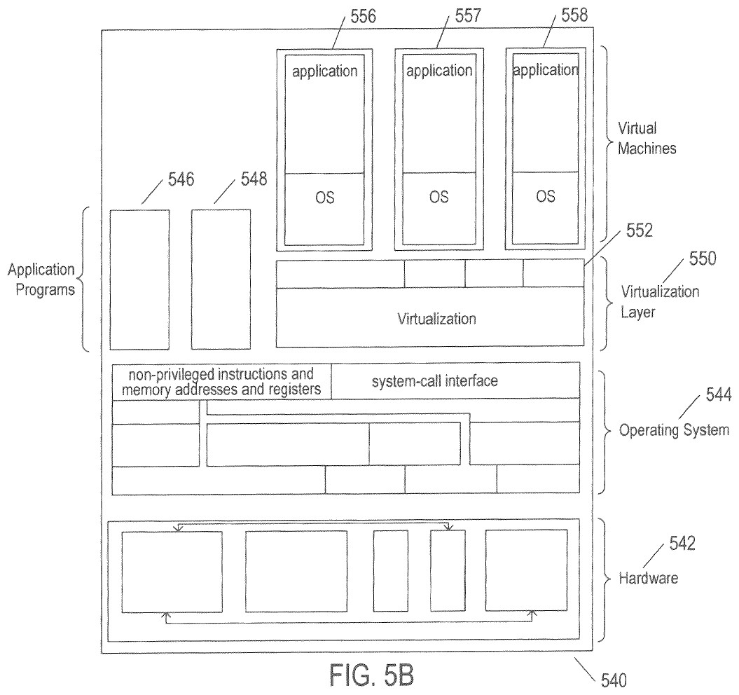

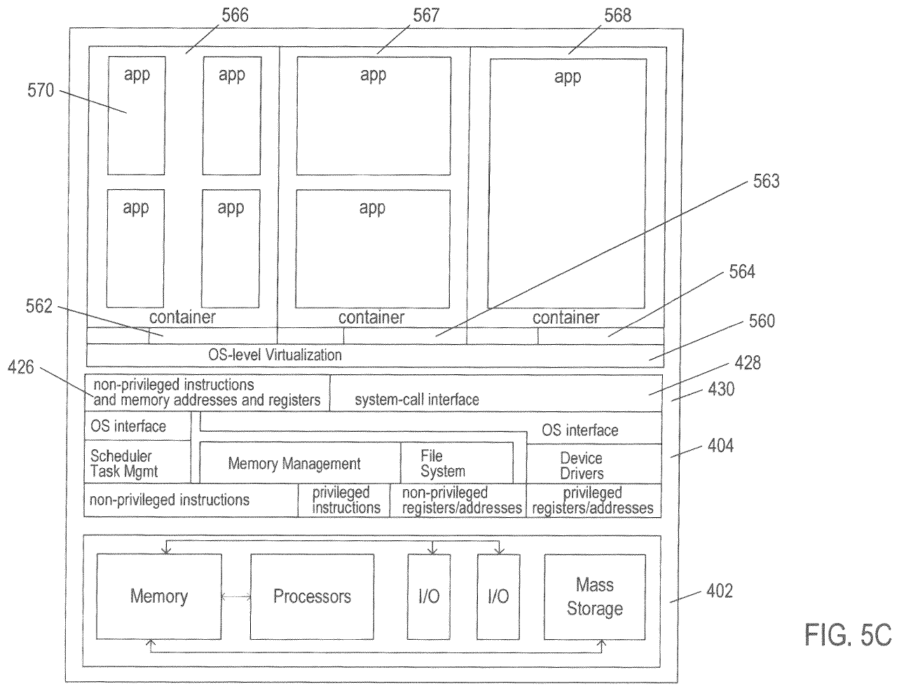

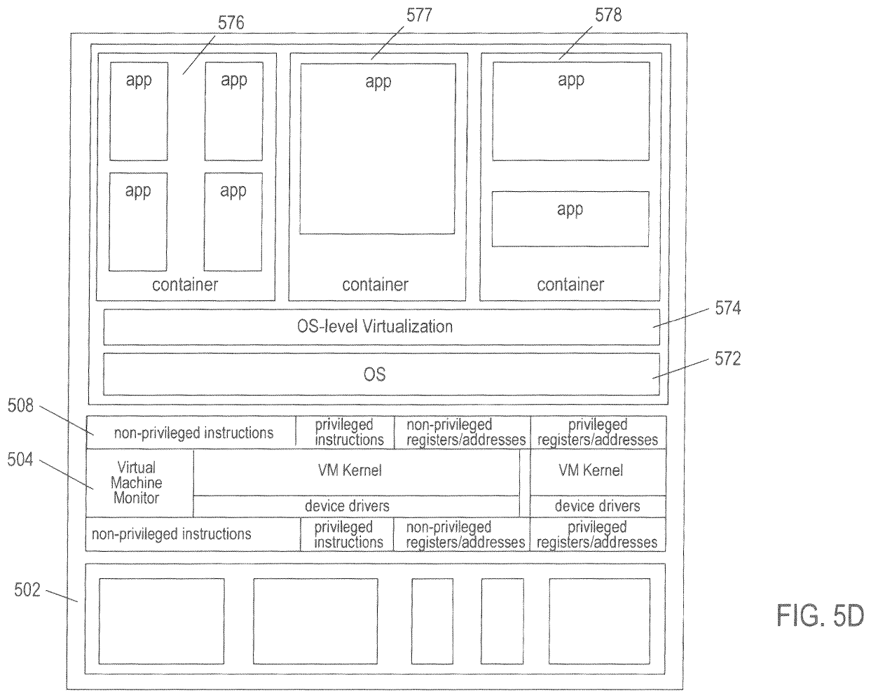

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous, distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as namespace support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

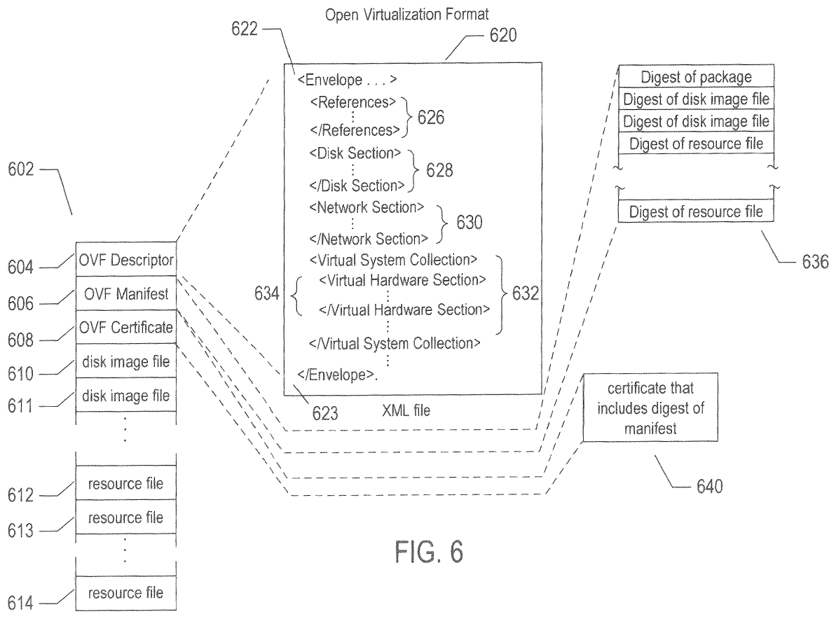

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

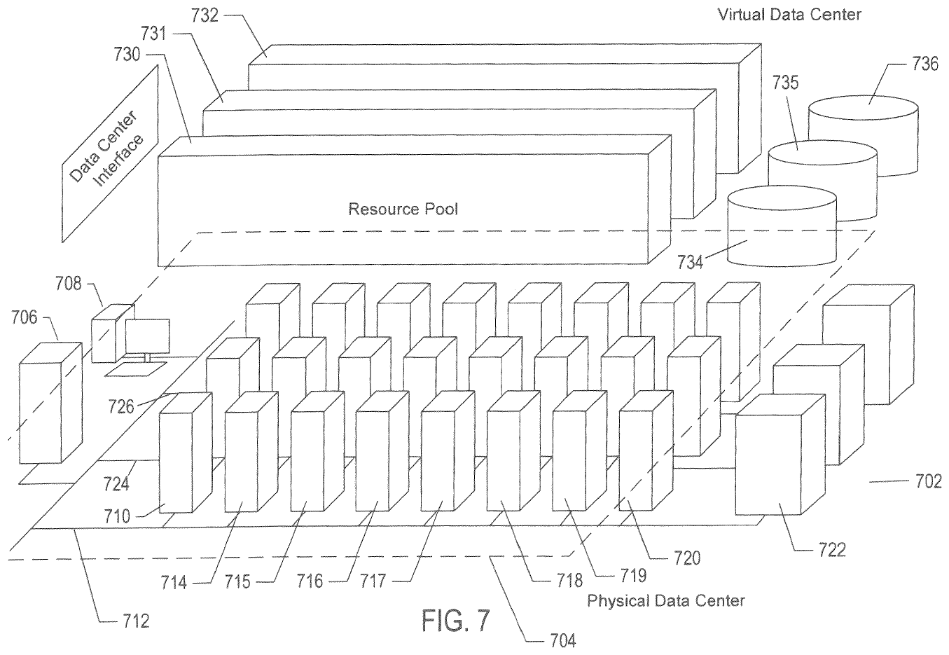

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

### Overview of an IaC Cloud-Infrastructure-Management Service

FIG. 8 illustrates a number of different cloud-computing facilities that provide computational infrastructure to an organization for supporting the organization's distributed applications and services. The cloud-computing facilities are each represented by an array of cabinets containing servers, data-storage appliances, communications hardware, and other computational resources, such as the array of cabinets 802. Each cloud-computing facility provides a management interface, such as management interface 804 associated with cloud-computing facility 802. The organization leases computational resources from a number of native-public-cloud cloud-computing facilities 802 and 806-810 and also obtains computational resources from multiple private-cloud cloud-computing facilities 811-813. The organization may wish to move distributed-application and distributed-service instances among the cloud-computing facilities to take advantage of favorable leasing rates, lower communications latencies, and desirable features and policies provided by particular cloud-computing facilities. In addition, the organization may wish to scale-up or scale-down the computational resources leased from different cloud-computing facilities in order to efficiently handle dynamic workloads. These types of operations involve issuing commands and requests through the management interfaces associated with the cloud-computing facilities. In the example shown in FIG. 8, cloud-computing facilities 802 and 806 are accessed through a first type of management interface, cloud-computing facilities 808 in 810 are accessed through a second type of management interface, and cloud-computing facilities 807 and 809 are accessed through a third type of management interface. The management interfaces associated with private-cloud cloud-computing facilities 811-813 are different from one another and from the native-public-cloud management interfaces.

The many different management interfaces represent a challenge to management and administration personnel within the organization. The management personnel need to be familiar with a variety of different management interfaces that may involve different command sets, different command-set syntaxes, and different features, In addition, the different management interfaces may accept different types of blueprints or cloud templates that specify the infrastructure and infrastructure configuration desired by the organization. It may be difficult for management personnel to determine whether certain desired features and functionalities easily accessed and obtained through certain types of management interfaces are even provided by cloud-computing facilities associated with other types of management interfaces. Different management interfaces may require different types of authentication and authorization credentials, which further complicates management operations performed by management and administration personnel. These problems may even be of greater significance when computational resources are leased from cloud-computing facilities and configured and managed by automated management systems.

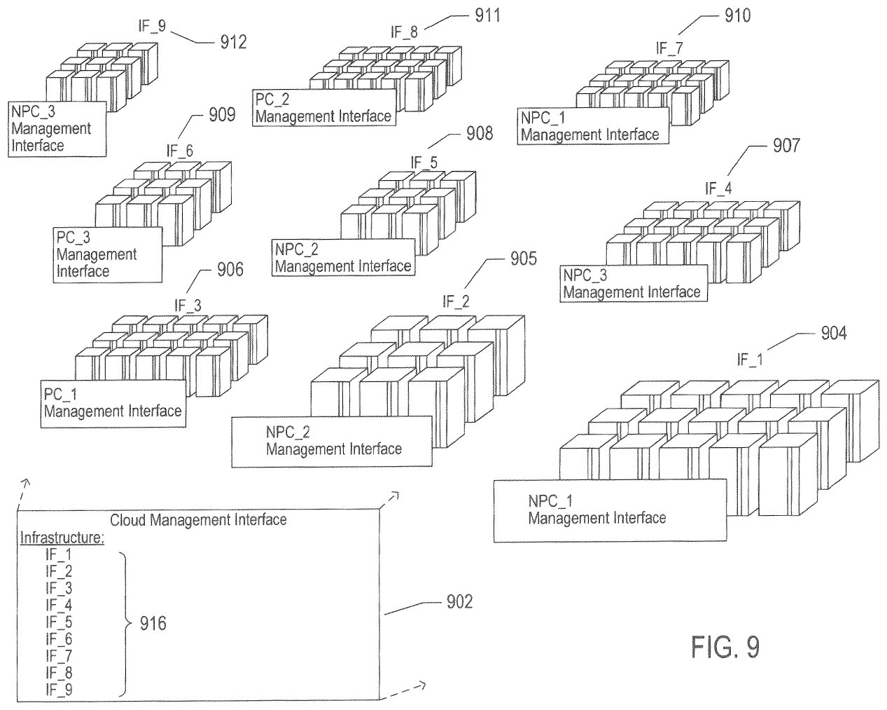

To address the problems associated with multiple different management interfaces to multiple different cloud-computing facilities, discussed in the preceding paragraph, the currently discussed IaC cloud-infrastructure-management service provides a single, universal management interface through which management and administration personnel as well as automated management systems define and deploy cloud-based infrastructure within many different types of cloud-computing facilities. FIG. 9 illustrates a universal-management-interface provided by the currently discussed IaC cloud-infrastructure-management service. The currently discussed IaC cloud-infrastructure-management service provides a cloud-management interface 902 through which both human management personnel and automated management systems can manage computational infrastructure provided by many different types of underlying cloud-computing facilities associated with various different types of management interfaces. The infrastructure deployed and configured within the various cloud-computing facilities is represented in FIG. 9 by the labels “IF_1” 904, “IF_2” 905, “IF_3” 906, “IF_4” 907, “IF_5” 908, “IF_6” 909, “IF_7” 910, “IF_8” 9011, and “IF_9” 912. The currently discussed IaC cloud-infrastructure-management service maintains the required authentication and authorization credentials for the different underlying cloud-computing facilities on behalf of human management personnel and automated management systems and automatically provides the required authentication and authorization credentials when accessing management interfaces provided by the different underlying cloud-computing facilities. One or more common types of cloud templates or blueprints are used to specify desired infrastructure and desired infrastructure configuration within the underlying cloud-computing facilities. Each different set of computational resources that together constitute an infrastructure within each of the cloud-computing facilities is visible, and can be managed, through the cloud-management interface 902, as indicated by the infrastructure labels 916 shown within the cloud-management interface.

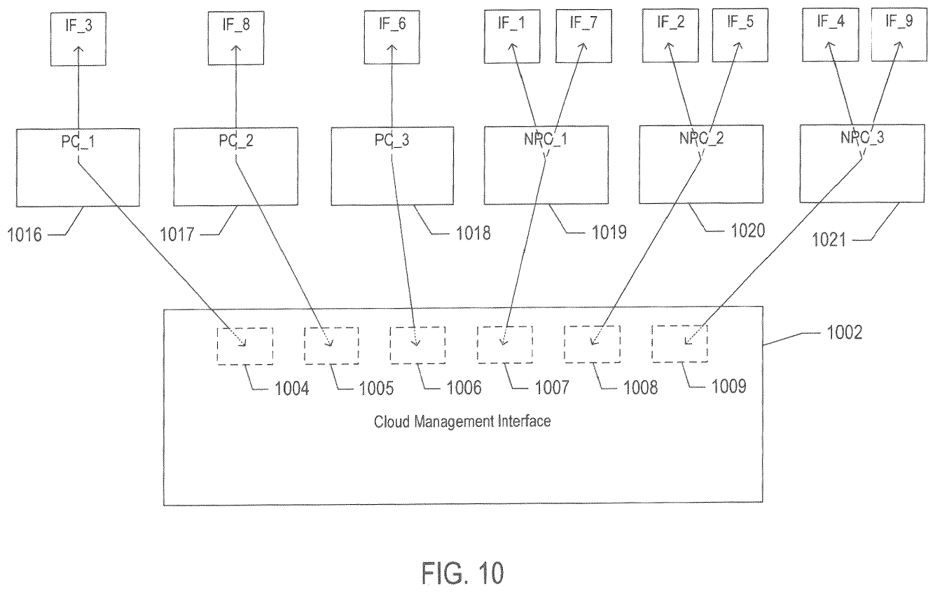

FIG. 10 illustrates the architecture of the currently discussed IaC cloud-infrastructure-management service. The IaC cloud-infrastructure-management service provides a cloud-management interface 1002 that includes a common or universal set of commands that can be used to deploy and configure infrastructure in many different types of private-cloud and native-public-cloud cloud-computing facilities that provide various types of cloud-management interfaces, allowing management and administration personnel and upstream automated infrastructure-management systems to deploy and configure infrastructure across the many different types of cloud-computing facilities through a common cloud-management interface 1002. The cloud-management interface 1002 is implemented by the IaC cloud-infrastructure-management service, discussed below. The IaC cloud-infrastructure-management service includes cloud-computing-facility-specific plug-ins, represented by dashed-line rectangles 1004-1009, that implement, together with control logic within the IaC cloud-infrastructure-management service, translation of the commands and features of the cloud-management interface 1002 to the commands and features of the underlying cloud-facility-specific management interfaces 1016-1021.

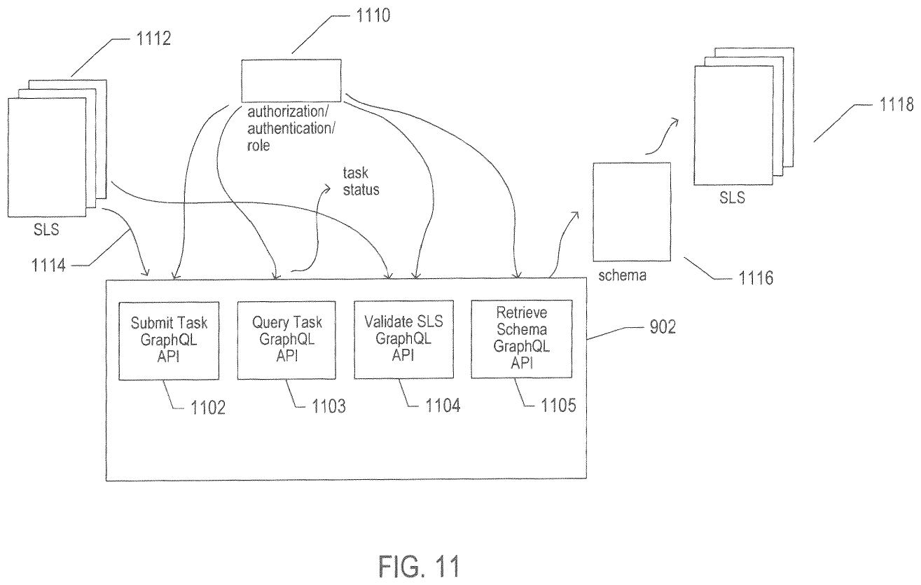

FIG. 11 illustrates the cloud-management interface provided by the currently discussed IaC cloud-infrastructure-management service. The cloud-management interface 902 includes four different GraphQL application programming interfaces (“APIs”): (1) Submit Task 1102, through which deployment-and-configuration commands are input to the IaC cloud-infrastructure-management service; (2) Query Task 1103, through which status queries for previously submitted deployment-and-configuration commands and requests are input to the IaC cloud-infrastructure-management service; (3) Validate SLS 1104, through which requests to validate SLS data are input to the IaC cloud-infrastructure-management service; and (4) Retrieved Schema 1105, through which the schemas for infrastructures within underlying computing-facilities can be requested from the IaC cloud-infrastructure-management service. Requests and commands input to the IaC cloud-infrastructure-management service are generally accompanied with an authorization/authentication/role certificate or token 1110, deployment-and-configuration tasks submitted to the Submit Task API are generally accompanied with SLS data 1112 (described below), and requests for validation of SLS data are accompanied with the SLS data to be validated, as indicated by curved arrows, such as curved arrow 1114, in FIG. 11. The schema 1116 returned when a command input to the Retrieve Schema API is executed is convertible into an SLS-data specification 1118 which can be input to the Submit Task API and/or modified and input to the Submit Task API.

There are, however, many different types of IaC cloud-infrastructure-management service or system implementations. For example, an IaC cloud-infrastructure-management service or system may be alternatively implemented as a collection of plug-ins that together comprise a cloud-infrastructure-management engine and a command-line interface (“CLI”). It is, for this reason, that the current document uses the phrase “service or system” to indicate that the currently discussed IaC cloud-infrastructure-management service is but one implementation approach to implementing cloud-infrastructure-management. To avoid repeating this phrase, the phrase “cloud-infrastructure manager” is used to refer to the various possible implementations of the currently discussed IaC cloud-infrastructure-management service or system.

### GraphQL Interface

FIG. 12 illustrates components of a GraphQL interface. The GraphQL interface is used as an API interface by various types of services and distributed applications. For example, as shown in FIG. 12, a server 1202 provides a service that communicates with a service client 1204 through a GraphQL API provided by the server. The service client 1204 can be viewed as a computational process that uses client-side GraphQL functionality 1206 to allow an application or user interface 1208 to access services and information provided by the server 1202. The server uses server-side GraphQL functionality 1210, components of which include a query processor 1212, a storage schema 1214, and a resolver component 1216 that accesses various different microservices 1218-1223 to execute the GraphQL-encoded service requests made by the client to the server. Of course, a GraphQL API may be provided by multiple server processes in a distributed application and may be accessed by many different clients of the services provided by the distributed application. GraphQL provides numerous advantages with respect to the Representational State Transfer (“REST”) interface technology, including increased specificity and precision with which clients can request information from servers and a potential for increased data-transfer efficiencies.

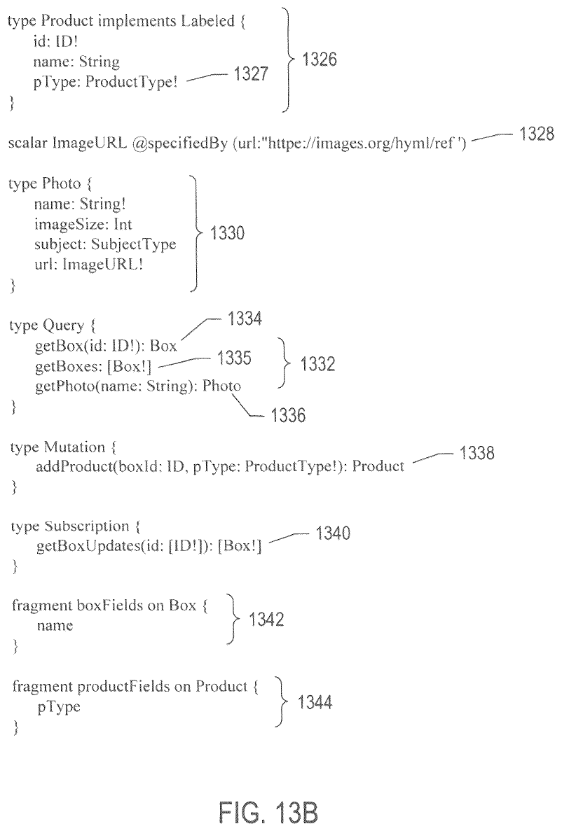

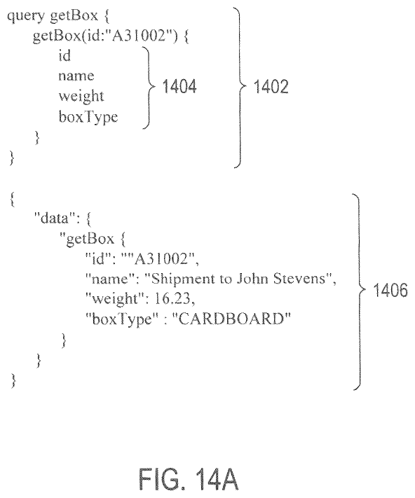

FIGS. 13A-E illustrate an example schema, an extension to that example schema, and queries, a mutation, and a subscription to illustrate the GraphQL query language. The example shown in FIGS. 13A-E does not illustrate all of the different GraphQL features and constructs, but a comprehensive specification for the GraphQL query language is provided by the GraphQL Foundation. A GraphQL schema can be thought of as the specification for an API for a service, distributed application, or other server-side entity. The example schema provided in FIGS. 13A-B is a portion of a very simple interface to a service that provides information about shipments of drafting products from a drafting-product retailer.

Three initial enumeration datatypes are specified in a first portion of FIG. 13A. The enumeration BoxType 1302 specifies an enumeration datatype with four possible values: “CARDBOARD,” “METAL,” “SOFT_PLASTIC,” and “RIGID_PLASTIC.” In the example schema, a box represents a shipment and the box type indicates the type of container in which the shipment is packaged. The enumeration ProductType 1304 specifies an enumeration datatype with eight possible values: “PENCIL_SET.” “ERASER_SET,” “INK_SET.” “PEN_SET.” “INDIVIDUAL_PENCIL,” “INDIVIDUAL_ERASER,” and “INDIVIDUAL_INK.” “INDIVIDUAL_PEN.” In the example schema, a shipment, or box, can contain products including sets of pencils, erasers, ink, and pens as well as individual pencils, erasers, ink, and pens. In addition, as discussed later, a shipment, or box, can also contain one or more boxes, or sub-shipments. The enumeration SubjectType 1306 specifies an enumeration datatype with four possible values: “PERSON,” “BUILDING,” “ANIMAL,” and “UNKNOWN.” In the example schema, the subject of a photograph is represented by one of the values of the enumeration SubjectType.

The interface datatype Labeled 1308 is next specified in the example schema. An interface datatype specifies a number of fields that are necessarily included in any object datatype that implements the interface. An example of such an object datatype is discussed below. The two fields required to be included in any object datatype that implements the interface Labeled include: (1) the field id 1309, of fundamental datatype ID; and (2) the field name 1310, of fundamental datatype String. The symbol “!” following the type specifier “ID” is a wrapping type that requires the field id to have a non-null value. The fundamental scalar datatypes in GraphQL include: (1) integers, Int; (2) floating-point values, Float; (3) Boolean values, Boolean; (4) string values, String; and (5) identifiers, ID. All of the more complex datatypes in GraphQL must ultimately comprise scalar datatypes, which can be thought of as the leaf nodes of a parse tree generated from parsing GraphQL queries, mutations, and subscriptions, discussed below. Wrapping datatypes include the non-null wrapping datatype discussed above and the list wrapping datatype indicated by bracketing a datatype, such as “[Int],” which specifies a list, or single-dimensional array, of integers or “[[Int]],” which specifies a list of lists or a two-dimensional matrix of integers.

The union Item 1312 is next specified in the example schema. A union datatype indicates that a field in an output data object can have one of the multiple datatypes indicated by the union specification. In this case, the datatype Item can be either a Box data object or a Product data object.

The Box object datatype 1314 is next specified in the example schema. An object datatype is a collection of fields that can have scalar-data-type values, wrapping-data-type values, or object data-type values. Because an object datatype may include one or more fields with object data-type values, object datatypes can describe hierarchical aggregations of data. The language “implements Labeled” 1315 indicates that the Box object datatype necessarily includes the interface Labeled fields id and name, discussed above, and those fields occur as the first two fields 1316 of the Box object datatype. The fields id and name represent a unique identifier and a name for the shipment represented by an instance of the Box object datatype. The additional fields in the Box object datatype include: (1) length 1317, of type Float, representing the length of the shipment container; (2) height 1318, of type Float, representing the height of the shipment container; (3) width 1319, of type Float, representing the width of the shipment container; (4) weight 1320, of type Float, representing the weight of the shipment container; (5) boxType 1321, of non-null enumeration type boxType, representing the type of shipment container; (6) contents 1322, an array of non-null Item data objects, representing the contents of the shipment; and (7) numItems 1323, of type Int, representing the number of items in the array contents. Since the field contents is an array of Item data objects, a box, or shipment, can contain one or more additional boxes, or sub-shipments. This illustrates how the GraphQL query language supports arbitrarily hierarchically nested data aggregations.

Turning to FIG. 13B, the example schema next specifics a Product 1326 object datatype that, like the Box object datatype, implements the interface Labeled and that additionally includes a field pType 1327 of enumeration type ProductType. An instance of the Product object datatype represents one of the different types of products that can be included in the shipment.

The example schema next specifies a custom scalar datatype ImageURL 1328 to store a Uniform Resource Locator (“URL”) for an image. The language “@specifiedBy( )” is a directive that takes a URL argument that references a description of how a String serialization of the custom scalar datatype ImageURL needs to be composed and formatted in order to represent a URL for an image. GraphQL supports a number of built-in directives and allows for specification of custom directives. Directives are essentially specifications of run-time execution details that are carried out by a server-side query processor that processes GraphQL queries, mutations, and subscriptions, discussed below. As another example, built-in directives can control query-execution to omit or include certain fields in returned data objects based on variables evaluated at the query-execution time. It should also be noted that fields in object datatypes may also take arguments, since fields are actually functions that return the specified datatypes. Arguments supplied to fields, like arguments supplied to directives, are evaluated and used at query-execution time by query processors.

The example schema next specifies the Photo object datatype 1330, which represents a photograph or image that can be accessed through the service API specified by the schema. The Photo object datatype includes fields that represent the name of the photo, and image size, the type of subject of the photo or image, and in image URL.

The example schema next specifies three queries, a mutation, and a subscription for the root Query, Mutation, and Subscription operations. A query, like a database query, requests the server-side GraphQL entity to return information specified by the query. Thus, a query is essentially an information request, similar to a GET operation on a REST API. A mutation is a request to alter stored information and is thus similar to a PUT or PATCH operation on a REST API. In addition, a mutation returns requested information. A subscription is a request to open a connection or channel through which a GraphQL client receives specified information as the information becomes available to the GraphQL server that processes the subscription request. Thus, the various data objects specified in the schema provide the basis for constructing queries, mutations, and subscriptions that allow a client to request and receive information from a server. The example schema specifies three different types of queries 1332 that can be directed, by a client, to the server via the GraphQL interface: (1) getBox 1334, which receives an identifier for a Box data object as an argument and returns a Box data object in response; (2) getBoxes 1335, which returns a list or array of Box data objects in response; and (3) getPhoto 1336, which receives the name of a photo or image as an input argument and returns a Photo data object in response. These are three examples of the many different types of queries that might be implemented in the GraphQL interface. A single mutation addProduct 1338 is specified, which receives the identifier for a Box data object and a product type as arguments and, when executed by the server, adds a product of the specified product type to the box identified by the Box data-object identifier and returns a Product data object representing the product added to the box. A single subscription getBoxUpdates receives a list of Box data-object identifiers, as an argument, and returns a list of Box data objects in each response returned through the communications channel opened between the client and server for transmission of the requested information, over time, to the client. In this case, the client receives Box data objects corresponding to any of the boxes specified in the argument to the subscription getBoxUpdates when those Box data objects are updated, such as in response to addProduct mutations submitted to the server.

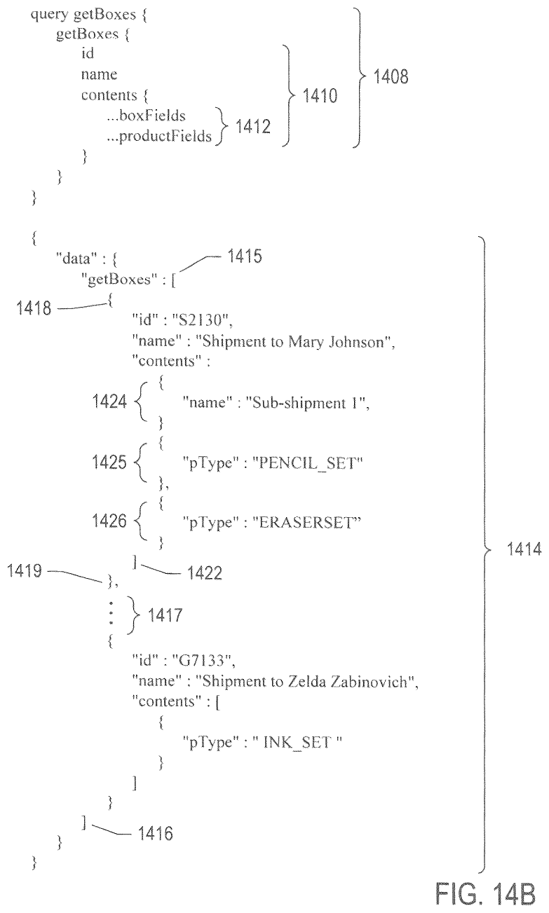

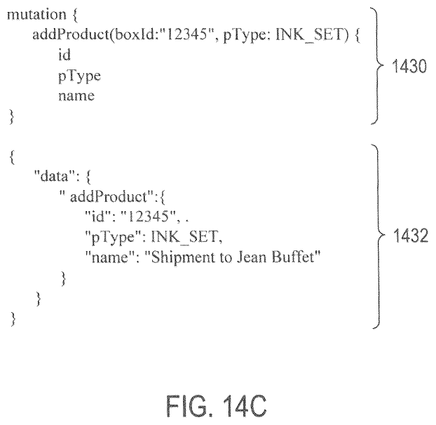

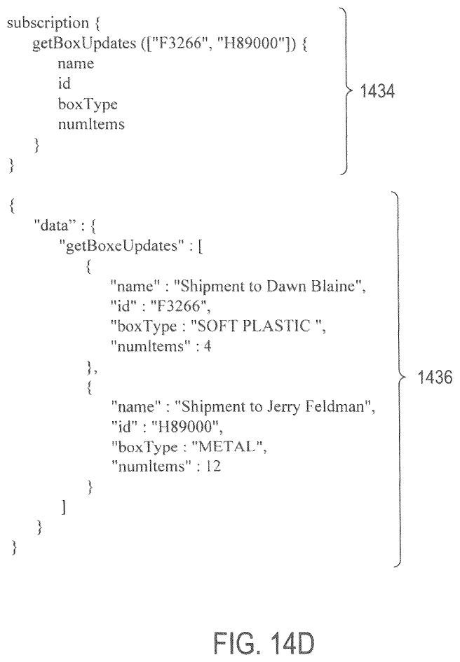

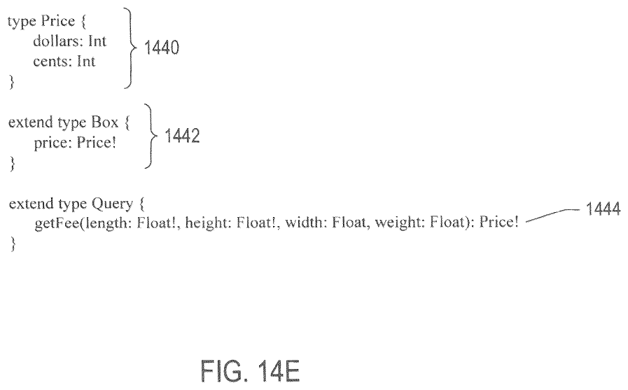

Finally, the example schema specifies two fragments: (1) boxFields 1342; and (2) productFields 1344. A fragment specifies one or more fields of an object datatype. Fragments can be used to simplify query construction by expanding a fragment, using the operator” . . . “in a selection set of a query, mutation, or subscription, as discussed below, rather than listing each field in the fragments separately in the selection set. A slightly different use of fragments is illustrated in example queries, below. In the current case, the fragment boxFields includes only the single field name of the Box data-object type and the fragment productFields includes only the single field name pType of the Product datatype. FIGS. 14A-D illustrates two example queries, an example mutation, and an example subscription based on the example schema discussed with reference to FIGS. 13A-B. FIG. 14A shows an example query 1402 submitted by a client to a server and the JavaScript Object Notation (“JSON”) data object returned by the server to the client. Various different types of data representations and formats can be returned by servers implementing GraphQL interfaces, but JSON is a commonly used data representation and formatting convention. The query 1402 is of the query type 1334 specified in FIG. 13B. The argument specified for the query is “A31002,” the String serialization of a Box identifier. A selection set 1404 for the query specifies that the client issuing the query wishes to receive only values for the id, name, weight, and boxType fields of the Box data object with identifier “A31002.” The JSON response to the query 1406 contains the requested information. This points to one of the large advantages provided by the GraphQL query language. A client can specify exactly the information the client wishes to receive from the server, rather than receiving predefined information for predefined queries provided by a REST interface. In this case, the client is not interested in receiving values for many of the fields in the Box data object and is able to use a selection set in the query to request only those fields that the client is interested in receiving.

FIG. 14B illustrates a second example query based on the example schema discussed with reference to FIGS. 13A-B. The second example query 1408 is of the query type 1335 specified in FIG. 13B. A selection set 1410 within the query requests that, for each Box data object currently maintained by the server, values for the id, name, and contents fields of the Box data object should be returned. The contents field has a list type and specifies a list of Item data objects, where an Item may be either a Box data object or a Product data object. A selection set 1412 for the contents field uses expansion of the boxFields and productFields fragments to specify that, for each Item in the list of Item data objects represented by the contents field, if the Item is a Box data object, then the value of the name field for that Box data object should be returned while, if the Item is a Product data object, then the value of the pType field of the Product data object should be returned. The JSON response 1414 to query 1408 is shown in the lower portion of FIG. 14B. The returned data is a list of the requested fields of the Box data object currently maintained by the server. That list begins with bracket 1415 and ends with bracket 1416. Ellipsis 1417 indicates that there may be additional information in the response for additional Box data objects. The requested data for the first Box data object occurs between curly brackets 1418 and 1419. The list of items for the contents of this Box data object begin with bracket 1420 and end with bracket 1422. The first Item 1424 in the list is a Box data object and the second two Item data objects 1425 and 1426 are Product data objects. The second example query illustrates that a client can receive a large amount of arbitrarily related information in one request-response interaction with a server, rather than needing to use multiple request-response interactions. In this case, a list of portions of multiple Box data objects can be obtained in one request-response interaction. As another example, in a typical REST interface, a client may need to submit a request to separately retrieve information for each Box data object contained within an outer-level Box data object, but, using a hierarchical object datatype, that information can be requested in a single GraphQL query.

FIG. 14C illustrates an example mutation based on the example schema discussed with reference to FIGS. 13A-B. The example mutation 1430 is of the mutation type 1338 specified in FIG. 13B. The mutation requests that the server add a product of type INK_SET to the Box data object identified by Box data-object identifier “12345” and return values for the id, pType, and name fields of the updated Box data object. The JSON response 1432 to query 1430 is shown in the lower portion of FIG. 14C. FIG. 14D illustrates an example subscription based on the example schema discussed with reference to FIGS. 13A-B. The example subscription 1434 is of the subscription type 1340 specified in FIG. 13B. The subscription requests that the server return, for updated Box data objects identified by Box data-object identifiers “F3266” and “H89000,” current values for the name, id, boxType, and numItems fields. One of the JSON responses 1436 to subscription 1434 returned at one point in time is shown in the lower portion of FIG. 14D.

FIG. 14E illustrates a second schema, based on the first example schema of FIGS. 13A-B and generated by extending the first example schema. The second schema may be used as an interface to a different service that returns shipment fees associated with Box data objects that represent shipments. The schema extension includes specification of a new Price data object 1440, extension of the object datatype Box to include an additional field price with a Price data-object value 1442, and extending the root Query operation type to include a getFee query 1444 that receives the length, height, width, and weight of a shipment and returns the corresponding shipment price or cost. Thus, GraphQL provides for extension of schemas to generate new extended schemas to serve as interfaces for new services, distributed applications, and other such entities.

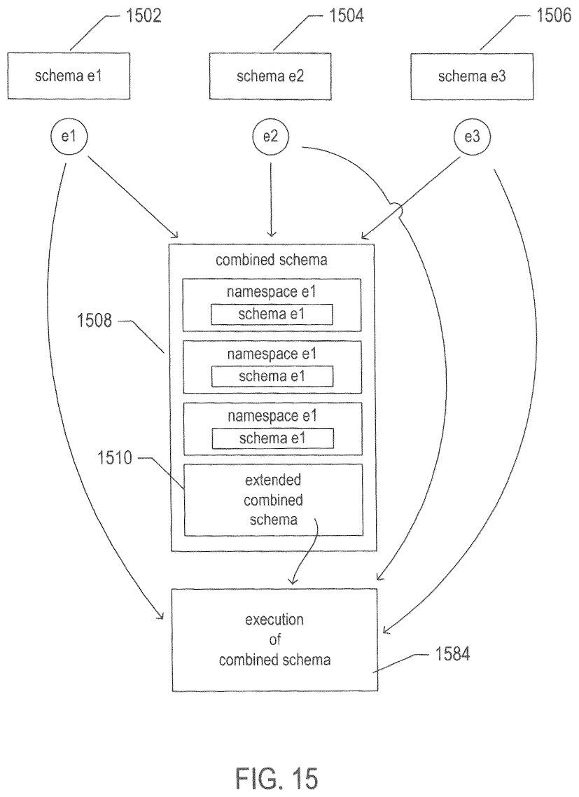

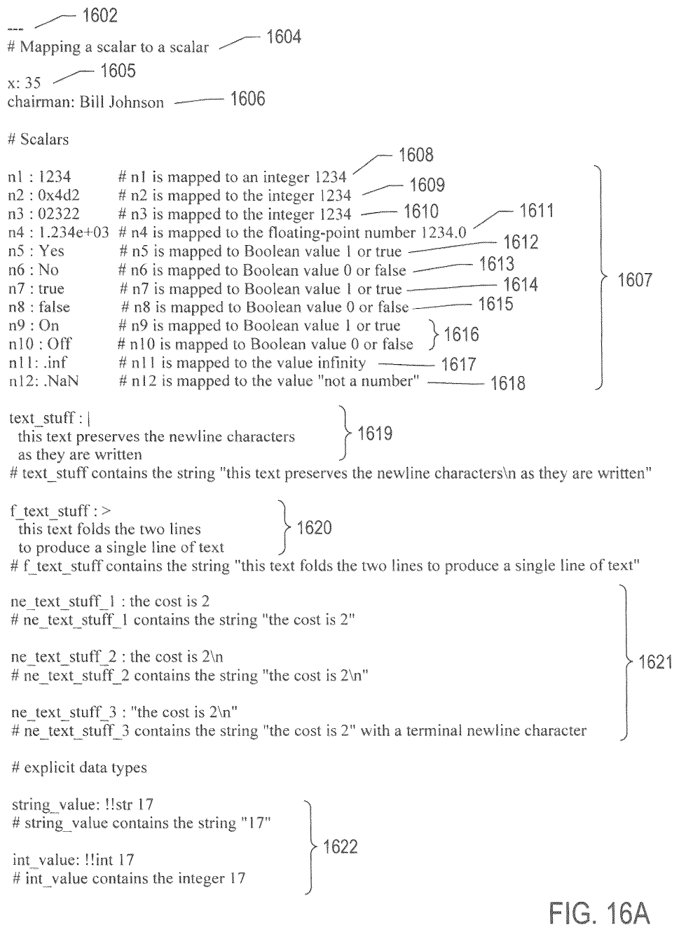

FIG. 15 illustrates a stitching process. Schema stitching is not formally defined by the GraphQL query-language specification. The GraphQL query-language specification specifies that a GraphQL interface is represented by a single schema. However, in many cases, it may be desirable to combine two or more schemas in order to produce a combined schema that is a superset of the two or more constituent schemas, allowing queries, mutations, and subscriptions based on the combined schema to employ object datatypes and other defined types and directives specified in two or more of the constituent schemas. There are multiple different types of implementations of schema stitching. In an example shown in FIG. 15, there are three underlying schemas 1502-1504. The stitching process combines these three schemas into a combined schema 1508. The combined schema includes the underlying schemas. In the illustrated approach to stitching, each underlying schema is embedded in a different namespace in the combined schema, which may include additional extensions 1510. The namespaces are employed in order to differentiate between identical identifiers used in two or more of the underlying schemas. Other approaches to stitching may simply add extensions to all or a portion of the type names defined in all of the underlying schemas in order to generate unique names across all of the underlying schemas. In the combined schema, queries, mutations, and subscriptions may use types from all of the underlying schemas and, in combined-schema extensions of underlying-schema types, a type defined in one underlying schema can be extended to reference a type defined in a different underlying schema. When a query, mutation, or subscription defined in the combined schema is executed, the execution 1514 may involve execution of multiple queries by multiple different services associated with the underlying schemas.

### YAML/JINJA and SLS Data

FIGS. 16A-D illustrate the YAML Ain′t Markup Language (“YAML”) data serialization language. YAML provides for representing data in text files. Certain features of YAML are illustrated by the YAML document shown in FIGS. 16A-D. A YAML document begins with three hyphens (1602 in FIG. 16A) and ends with three periods (1603 in FIG. 16D.) Multiple YAML documents can be included in a single text file. Comments begin with a “#” symbol followed by a space, such as the comment 1604. One of the fundamental constructs in YAML is a mapping of a scalar value to a scalar string, or name, such as the mapping 1605 of the integer value 35 to the name “x” and the mapping 1606 of the string value “Bill Johnson” to the name “Chairman.” YAML supports a variety of different types of scalars, as shown in the set of mappings 1607, including: integers encoded as decimal integers 1608, integers encoded as hexadecimal integers 1609, and integers encoded as octal integers 1610; floating-point numbers 1611; Boolean values “Yes” 1612 and “No” 1613, “true” 1614 and “false” 1615, and “On” and “Off” 1616; a value representing infinity 1617; and a value representing “not a number” 1618. On lines 1619, two text lines are mapped to the name “text_stuff,” with the symbol “|” used to indicate that newline characters in the text should be preserved. On lines 1620, two text lines are mapped to the name “f_text_stuff.” with the symbol “>” indicating that newlines should be removed in order to fold the text into a single text block. Text can be unquoted or quoted, as indicated by the examples on lines 1621. The “!!” operator can be used to explicitly assign types to values, as indicated on lines 1622.

Turning to FIG. 16B, another fundamental data structure supported by YAML is the sequence or list. Several different representations of lists are supported. In a first representation of a list 1623, the elements of the list are indicated by a preceding “-” and a space. In a second representation 1624, the elements of the list are contained within brackets and separated by commas and spaces. As indicated on lines 1625, a list can be mapped to a name. In the example of lines 1625, a list of animals is mapped to the character string, or name, “animals.” Note that indentation is used, as in the Python programming language, to indicate hierarchical structure.

Lines 1626 show a mapping of a more complex type of list to the name, or character string, “members.” In this example, the list is a list of blocks 1627-1629. Each block is preceded by a hyphen and a space. Each block contains a mapping of a character string to the character string “name” 1630, a mapping of two text lines to the character string “address” 1631, a mapping of an integer to the character string “age” 1632, and a mapping of an alphanumerically encoded phone number to the character string “phone” 1633. In the example of lines 1634 at the bottom of FIG. 16B and lines 1635 at the top of FIG. 16C, the mapping of the list of blocks to the character string “members” on lines 1626 of FIG. 16B is modified to include two additional lines in each block of the list. The two additional lines are specified using the anchor symbol “&” on lines 1636 at the bottom of FIG. 16B. The lines are included at the end of each block in the list using the reference prefix “<<:*” at the beginning of each of three lines referencing the anchor “chapter” 1637-1639. The modified list is equivalent to the list shown on lines 1640 of FIG. 16C. Finally, on line 1641 at the top of FIG. 16D, a more complex mapping that maps the list “[0, 1, 2]” to the list “[small, medium, large]” is shown. This mapping can alternatively be represented by the map sequence, or dictionary, shown on line 1642. The example YAML document shown in FIG. 16A-D does not, of course, provide a comprehensive description of the YAML data-representation language, but is instead intended to show some of the main features and constructs of YAML that are used in SLS documents, discussed below.

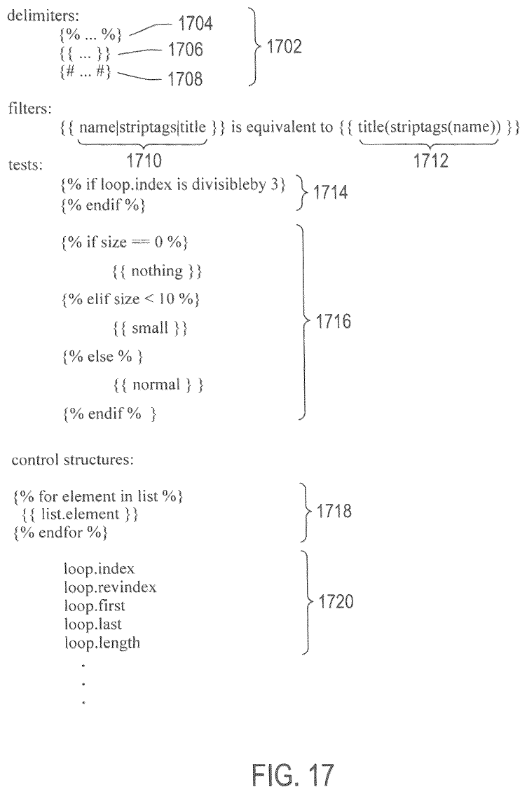

FIG. 17 illustrates certain features provided by the Jinja template engine that are used, in addition to YAML, for representing infrastructure in SLS documents. Jinja employs several types of delimiters to encode Jinja constructs. These are shown on lines 1702 of FIG. 17, with ellipses indicating that additional text is enclosed by the delimiters. A first type of delimiter 1704 is used to encapsulate tests, control structures, and other programming-language-like constructs. A second type of delimiter 1706 is used to encapsulate variables for output. A third type of delimiter 1708 is used to enclose comments. Pipe symbols “|” can be used to indicate sequences of function calls. For example, the delimited string “name|striptags|title” 1710 is equivalent to the character string 1712, which represents calling a function “title” with an argument that represents a value returned by calling the function “striptags” with the argument “name.” Jinja supports if statements, as shown by the example on lines 1714, and if-elseif-else statements, as shown by the example on lines 1716. Jinja provides a set of comparison operators used in if and if-elseif-else statements. Finally, Jinja provides various types of control structures, such as for-loops, as indicated on lines 1718. The for-loop control structure is accompanied with a number of Jinja loop variables 1720 that can be used in conditional expressions within loops. FIG. 17 does not provide a comprehensive list of examples of Jinja features and constructs, but is instead intended simply to show some of the main types of Jinja constructs that, in combination with YAML constructs and features, are used in SLS documents, described below.

The currently discussed cloud-infrastructure-management service is referred to as the “Idem service” in the remainder of this document, for reasons discussed in a following section. Similarly, the currently discussed cloud-infrastructure-management system comprising a cloud-infrastructure-management engine and a CLI interface is referred to as the “Idem system” in the remainder of this document. The phrase “Idem manager” refers to a cloud-infrastructure management server or system. The Idem service, as discussed above, receives SLS data files that describe deployment and configuration of cloud-based infrastructure. SLS data files can be represented in various different data-serialization languages, including JSON, but a combination of YAML-like and Jinja-like formatting conventions, features, and constructs are most frequently used. An Idem state file is an SLS data file that represents configuration of a cloud-based infrastructure, and Idem SLS data files serve as blueprints or cloud templates input to the Submitted Task and Validate SLS APIs of the Idem-service management interface. There are, however, many different types of Idem implementations. Idem may be considered to be a data flow programming language, for example, and an Idem system may be implemented as a collection of plug-ins that together comprise a cloud-infrastructure-management engine and a command-line interface (“CLI”). In the current document, the Idem service introduced, above with reference to FIGS. 9-11, is used as an example cloud-infrastructure-management system in which the currently discussed automated methods for generating parameterized cloud templates corresponding to already deployed and configured cloud infrastructure can be incorporated, but the currently discussed automated methods can alternatively be incorporated in other types of Idem implementations.

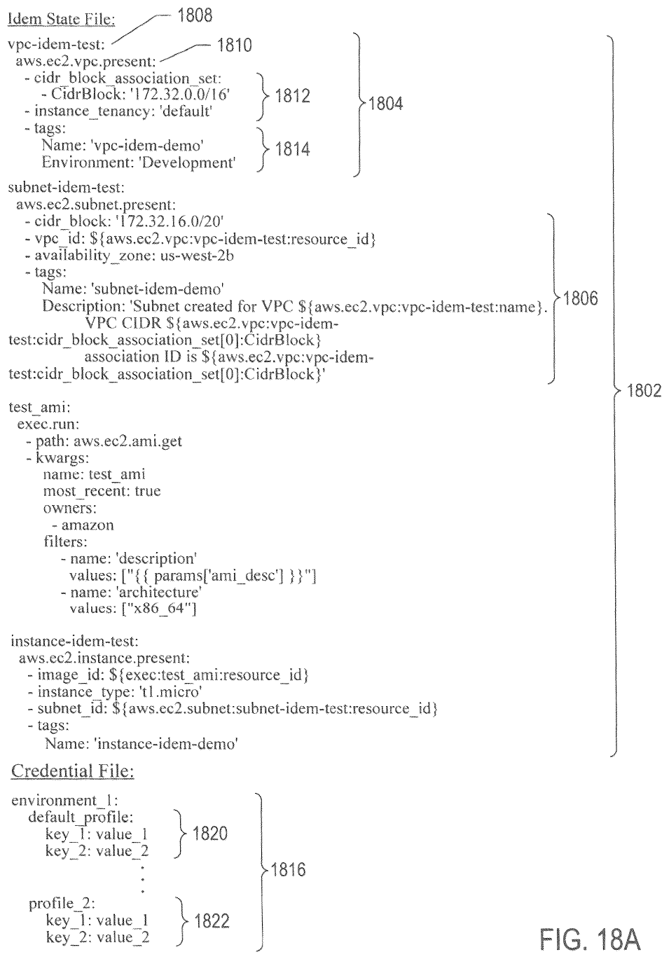

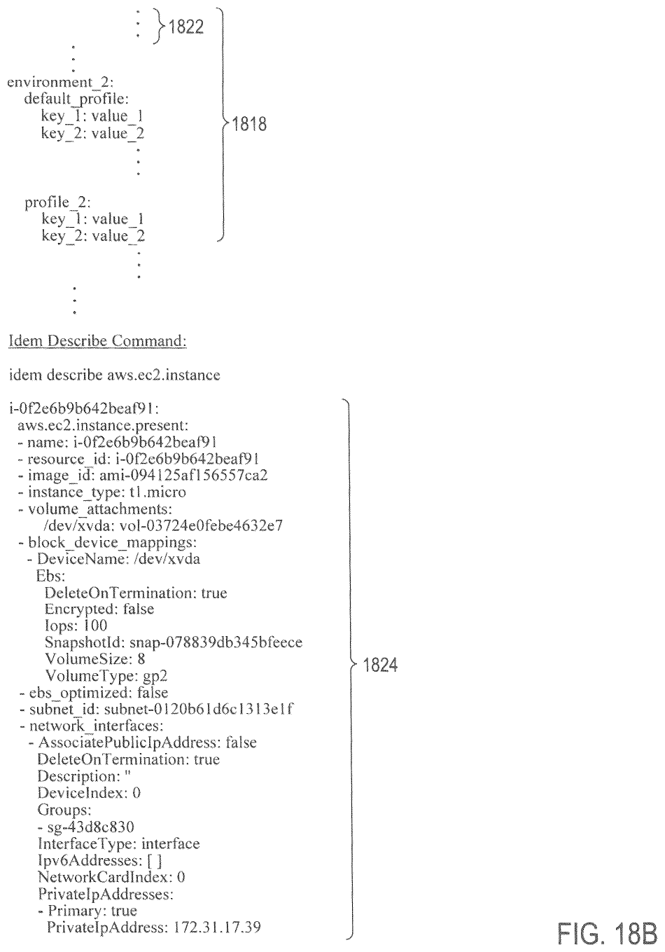

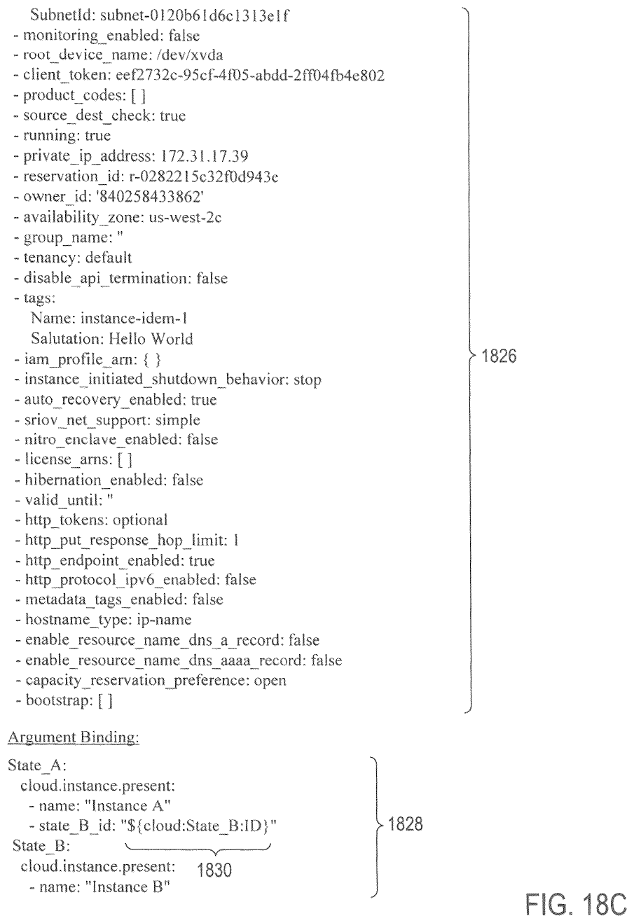

FIGS. 18A-C illustrate a structured layered state (“SLS”) data file and an SLS credential file as well as the output from an Idem describe command. A simple, example Idem state file is shown in the initial portion 1802 of FIG. 18A. The example SLS state file creates a virtual private cloud (“VPC”) for a virtual machine within an AWS cloud-computing facility and connects the VPC to an AWS subnet. A first portion of the example SLS state file 1804 specifies the VPC and a second portion of the example SLS state file 1806 specifies the subnet. Each resource includes a state name, such as “vpc-item-test” 1808 for the VPC, and a directive, or function, such as “aws.cc2.vpc.present” 1810. Directives include: (1) present, which indicates that, when the resource is not currently present in the infrastructure, the resource should be allocated, deployed, and configured according to the resource specification and that, when the resource is currently present in the infrastructure, the Idem service resource should ensure that the current deployment and configuration of the resource corresponds to the resource specification; (2) absent, which indicates that, when the resource is currently allocated and deployed, the resource should be removed; and (3) describe, which requests that the Idem service return information about the resource. Resources are specified using a plug-in/resource-group/resource-type tuple, such as “aws.ec2.vpc” in directive 1810. The plug-in portion of the plug-in/resource-group/resource-type tuple refers to a plug-in associated with a particular cloud-computing facility or cloud provider which provides the executables for accessing the particular cloud-computing facility and/or a set of cloud-computing facilities managed by the cloud provider. A resource specification includes a list of attribute/value pairs, generally including property/value pairs 1812 tag/value pairs 1814. Of course, real-world Idem state files may contain descriptions of hundreds or thousands of resources and, in addition, a blueprint or cloud templates may include multiple hierarchically organized SLS state files. The resource-group portion of the plug-in/resource-group/resource-type tuple refers to a group or class containing multiple types of resources and the resource-type portion of the plug-in/resource-group/resource-type tuple refers to a particular type of resource, such as a virtual machine or a subnet, which is a partition of the host-address space of a virtual-private-network-address space.

The form of an SLS credential file is shown in a lower portion 1816 of FIG. 18A and an upper portion 1818 of FIG. 18B. The SLS credential file contains a block of authentication/authorization information for one or more environments, each of which corresponds to plug-ins for different types of cloud-computing-facility management interfaces.

The first portion 1816 of the example SLS credential file shown in FIG. 18A contains a block of authentication/authorization information for a first environment. Each block contains authentication/authorization information for one or more profiles, such as profiles 1820 and 1822 in the block for the first environment, including a default profile 1820. The authentication/authorization information is encoded as a set of attribute/value pairs, such as the name of a particular type of authentication/authorization information, such as an access key, and the alphanumerically encoded access key. SLS credential files are used to input authentication/authorization information to the Idem-service management interface so that the authentication/authorization information can be maintained by the Idem-service management interface and used by the Idem service to access functionality provided by the management interfaces of cloud-computing facilities via the various plug-ins.

The lower portion 1824 of FIG. 18B and the upper portion 1826 of FIG. 18C show the output of an Idem-service describe command executed with respect to the infrastructure described in the Idem state file 1802 shown in FIG. 18A. The output of the Idem-service describe command has a YAML-like format and can be used to generate a corresponding Idem state file that can be subsequently used to modify and enforce the configuration of the represented infrastructure, as discussed below. A final portion 1828 of FIG. 18C illustrates argument binding in SLS data files. The character string “${cloud: State_B: ID}” represents a reference to an attribute value of an attribute in an SLS data file generated by prior execution of a portion of an SLS data file. In the example shown in the final portion of FIG. 18C, the string “${cloud: State_B: ID}” references the name of the resource State_B once that name is obtained via an Idem-service state command. Moreover, execution of the Idem-service state command orders execution of operations related to specified resources to ensure that argument bindings refer to valid attribute values.

In fact, the SLS data files that specify resources and relationships between the resources within cloud infrastructure and that specify the configuration of the resources contain very little code, instead containing primarily a data description such as the data description supported by YAML, JSON, XML, and other data-description languages. For this reason, it might be more accurate to describe the Idem service and Idem system as an “Infrastructure-as-Data cloud-infrastructure-management” service and system, rather than as an “Infrastructure-as-Code cloud-infrastructure-management” service and system. However, rather than introduce yet another acronym, the current application continues to refer to the Idem service and Idem system as an “Infrastructure-as-Code cloud-infrastructure-management” service and system, respectively.

### Infrastructure-as-Code Cloud-Infrastructure-Manager in which the Currently Disclosed Graph-Based User Interface is Included

As discussed above, the current application discloses a cloud-infrastructure-management service referred to as the “Idem service” as well as a cloud-infrastructure-management engine and CLI interface referred to as the “Idem system,” with the phrase “Idem manager” referring to either or both of the Idem service and Idem system. These names are derived from the term “idempotent.” An idempotent operation is an operation that can be first applied to an object or entity and, when the object or entity is not subsequently altered by other operations, can be again applied to the object or entity without changing the object or entity. One example of an idempotent operation is the computational operation x=x mod 5, where the initial value of x is 16. The first application of the operation x=x mod 5 sets the value of x to 1. Provided that the value of x is not altered by some other operation, a second application of the operation x=x mod 5 results in the value of x remaining 1, and this is true for any number of repeated applications of the operation x=x mod 5 provided that the value of x is not altered by application of some other operation.

FIG. 19 illustrates a fundamental control loop involving the Idem service. This control loop involves the Idem-service state command, mentioned above, which applies an SLS-data blueprint or cloud template to a cloud-computing facility. In the case that no infrastructure has yet been deployed and configured within the cloud-computing facility on behalf of the individual or organization submitting the Idem-service state command to the management interface of the Idem service, the Idem service creates, deploys, and configures infrastructure on the cloud-computing facility according to the SLS-data blueprint or cloud template. When the resulting infrastructure is not subsequently altered by other commands or events, then, when the individual or organization again submits the same SLS-data blueprint or cloud template in a subsequent Idem-service state command to the management interface of the Idem service, the infrastructure is not changed by the subsequent Idem-service state command. However, in the case that the infrastructure has been altered by various events following the initial creation, deployment, and configuration of the infrastructure, submission of the same SLS-data blueprint or cloud template in a subsequent Idem-service state command to the management interface of the Idem service returns the infrastructure to the state that the infrastructure had upon initial creation, deployment, and configuration. Thus, the Idem-service state command associated with a particular SLS-data blueprint or cloud template is idempotent, and resubmission of an Idem-service state command associated with a particular SLS-data blueprint or cloud template can be used to control unintended departures of the state of cloud-based infrastructure, referred to as “enforcement,” without the risk of causing unintended changes to the state of the infrastructure defined by the SLS-data blueprint or cloud template.

The idempotency of the Idem-service state command is reflected in the fundamental control loop 1902 illustrated in FIG. 19. There are two possible starting points 1904 and 1906 for the control loop 1902. Assuming that the loop begins at the starting point 1904, the loop begins with an SLS-data blueprint or cloud template 1908 that describes desired infrastructure to be created, deployed, and configured within a cloud-computing facility. The SLS-data blueprint or cloud template is referenced by an Idem-service state command 1910 which is submitted to the Idem service for execution 1912. Execution of the Idem-service state command 1910 produces deployed and configured infrastructure 1914 with a state corresponding to a desired state represented by the SLS-data blueprint or cloud template. Subsequent submission of an Idem-service describe command 1916 result in execution of the describe command by the Idem service 1918 which, in turn, produces Idem-service-describe-command output 1920 that represents the current state of the infrastructure. At this point, if the output from the Idem describe command does not reflect the desired state of the infrastructure, the original SLS data can be referenced by a resubmitted Idem-service state command to enforce the originally desired infrastructure state. This enforcement operation is used to correct infrastructure drift, where “infrastructure drift” means an unintended departure of the state of the infrastructure from the desired state due to intervening events or operations. By contrast, if the loop started at starting point 1906, then the output from the Idem-service describe command can be translated into SLS data that can be subsequently used to enforce the infrastructure state represented by the SLS data. Yet another possibility is that the infrastructure state represented by the describe-command output may be used to generate corresponding SLS data which can then be modified in order to generate a new infrastructure state. Thus, the fundamental control loop may continue to iterate in order to maintain the state of the infrastructure in a desired state, with modifications to the SLS-data blueprint or cloud template made to alter the infrastructure state in response to changing goals or conditions.

FIG. 20 illustrates one implementation of the Idem service. The Idem service 2002 includes an Idem-service frontend 2004, a task manager 2006, multiple Idem-service workers 2008, with the number of Idem-service workers scalable to handle dynamic workloads, an event stream 2010, and an event-processing component 2012. The Idem-service frontend 2004 includes the previously discussed set of GraphQL APIs 2014 and a database 2016 for storing information related to managed infrastructure and received Idem requests and commands. The frontend additionally includes Idem-service logic 2018 that implements command/request execution, throttling and prioritization, scheduling, enforced-state management, event ingestion, and internal communications between the various components of the Idem service. Throttling involves managing the workload accepted by the Idem service to ensure that sufficient computational resources are available to execute received commands and requests. Prioritization involves prioritizing execution of received Idem commands and requests. Scheduling involves preemption of long-running Idem-command-and-request executions. Enforced state management involves maintaining a representation of the last enforced state of a particular infrastructure managed by the Idem service in order to facilitate subsequent command/request execution. Event ingestion involves receiving, storing, and acting on events input to the Idem-service frontend by the event-processing component 2012. The various components of the Idem service communicate by message passing, as indicated by double-headed arrows 2020-2022. The task manager 2006 coordinates various stages of execution of Idem commands and requests using numerous task queues 2024-2026. Each Idem-service worker, such as Idem-service worker 2028, presents an Idem-service worker API 2030 and includes logic 2032 that implements Idem-command-and-request execution. Each Idem-service worker includes a set of one or more plug-ins, such as plug-in 2034, allowing the Idem-service worker to access the management interfaces of cloud-computing facilities on which infrastructure managed by the Idem service is deployed and configured. As they execute commands and requests, Idem-service workers publish events to the event stream 2010. These events are monitored and processed by the event-processing component 2012, which filters the events and forwards processed events to the Idem-service frontend.

### Currently Disclosed Methods and Systems

As discussed above, SLS data files provide the specifications and configuration information for cloud infrastructure managed by an Idem manager. Although, as discussed above, an Idem manager provides many advantages to those who manage and administer cloud infrastructure, it may be difficult for managers and administrators who are currently managing deployed cloud infrastructure using currently available, non-Idem management tools, to read and understand SLS cloud-infrastructure-specification-and-configuration data files, to modify SLS data files, and to develop new cloud-infrastructure specifications and configurations by developing new SLS cloud-infrastructure-specification-and-configuration data files. These tasks may involve relatively time-consuming efforts to learn how to properly represent resource specifications and configurations in SLS data files. Even for those who understand the syntax and terminology used to generate SLS data files, reading through hundreds or thousands of pages of SLS data files to identify specific resource specifications and resource-relationship specifications may represent an onerous, time-consuming manual process that cloud-infrastructure administrators and managers would choose to avoid were there better alternatives.

To resolve the problem discussed in the preceding paragraph, the current document discloses a graph-based user interface (“GBUI”) that provides an alternative, easy-to-interpret, visual representation of the information contained in SLS data files and that provides an interface for editing and generating SLS data files in addition to visually accessing the information contained in SLS data files. The currently disclosed GBUI represents a significant improvement to currently available IaC cloud-infrastructure-management-and-configuration systems and services, including the Idem system and the Idem service. SLS data files remain the information source for Idem-manager operation, but the currently disclosed GBUI provides, to human administrators and managers, easier and more intuitive access to the information source that underlies Idem-manager operation.

FIG. 21 illustrates the currently disclosed graph-based user interface (“GBUI”). The GBUI 2102 is displayed on a laptop, desktop computer system, smart phone, administrator console or terminal, or other processor-controlled device or apparatus 2104 having a graphical-display component. The GBUI may be directly provided, via a client-side web browser, by an Idem manager 2106. As discussed above, the Idem manager instantiates and manages cloud infrastructure within one or more cloud-computing facilities 2108-2109 according to specifications and configuration information contained in a set of SLS data files 2112. The Idem manager processes the SLS data files to generate a graph representation 2114 of the contents of the SLS data files, along with one or more indexes and other stored information, and the GBUI functions as a user-controlled viewing window into the graph representation, allowing a user to navigate through the graph, edit the underlying SLS data files, and generate new SLS data files. In this fashion, the GBUI, along with additional administration-and-management tools provided by the Idem manager, discussed above, can serve as a general user interface to a cloud-infrastructure-specification-and-management manager. It should be emphasized that the graph representation 2114 of the SLS the data files 2112 that is viewed and modified through the GBUI represents a very different approach to user interfaces for cloud-infrastructure-management-and-configuration systems and services than provided by current cloud-infrastructure-management-and-configuration systems and services. Currently, user interfaces for cloud-infrastructure-management-and-configuration systems and services generate graphical information displays from information about cloud infrastructure provided by cloud-provider user interfaces and/or management systems that, in turn, is obtained through cloud-provider management systems running within cloud-computing facilities. The currently disclosed GBUI, by contrast, provides a graphical representation of the cloud-infrastructure specifications and configurations encoded in SLS data files that control the instantiation and management of cloud infrastructure by the Idem manager. This provides much faster and more efficient access to the information displayed by the GBUI. The currently disclosed GBUI relies on the cloud-infrastructure management-and-control facilities of an Idem manager to propagate modifications to resource specifications and configurations to the cloud-infrastructure implemented in cloud-computing facilities rather than using redundantly developed facilities for interfacing to the cloud-provider interfaces of many different cloud providers and cloud-computing facilities. In this way, the currently disclosed GBUI avoids complex operations needed to update the SLS data files to ensure that the SLS data files properly reflect specification and configuration changes made to the cloud infrastructure through an interface that directly interfaces to cloud-provider management interfaces.

The currently disclosed GBUI may also be implemented as a standalone service or system that allows users to view and modify the contents of SLS data files. Furthermore, the currently disclosed GBUI is easily enhanced to provide for viewing and modifying the contents of a variety of different types of specification-and-configuration files, including other types of cloud-infrastructure specification-and-configuration files produced and used by non-Idem cloud-infrastructure managers.

FIG. 22 illustrates an initial step in processing a set of SLS data files for representation as a graph by the currently disclosed GBUI. In the first step, the SLS data files 2202 are parsed to extract data representations of resources, or resource objects 2204-2207. As discussed above, the data representations of resources are represented in the SLS data files by a state name, a function call, including a directive, such as the directive present, and a number of property/value pairs. Property/value pairs may be nested, with the nesting indicated by levels of indentation, as discussed above. The data representations of resources in the SLS data files are extracted to generate resource objects, such as resource object 2204, which, in the disclosed implementation, include fields containing a resource identifier 2210, an encoding of the location of the data representation for the resource object in the SLS data file 2212, a resource type 2214, a resource name 2216, and a number of property/value pairs 2218. Ellipses 2220 and 2222 indicate that there are generally a large number of resource objects extracted from the set of SLS data files that together represent cloud infrastructure.

FIG. 23 illustrates a concept underlying a second step in processing a set of SLS data files for representation as a graph by the currently disclosed GBUI. The resource objects extracted from a set of SLS data files are shown in column 2302. The resource objects may be hierarchically related to one another through relationships, where the relationships are encoded in property/value pairs. In the example shown in FIG. 23, resource object 2304 contains property/value pairs that act as references, represented by curved arrows 2306-2310, to other resource objects. These relationships, and the resource objects connected by the relationships, can be translated into a nascent subgraph 2312 in which the resource represented by resource object 2304 is a root node 2314 and the resources represented by resource objects referenced from resource object 2304 are child nodes 2316-2320. An initial processing pass over the set of resource object 2302 may result in the generation of multiple nascent subgraphs 2312 and 2322-2325. Because an initial processing pass, at each point of processing, may be unaware of many of the resource objects and resource relationships in as yet unprocessed portions of the SLS data files, the initial processing pass generally produces a number of nascent subgraphs which, upon additional processing passes, are expanded into a forest of subgraphs or trees, with each subgraph or tree representing a hierarchically related subset of the set of resources specified in a set of SLS data files. For example, a virtual private cloud may include a number of subnet components which, in a graph representation, becomes a tree rooted in a root node representing the virtual private cloud and including subnet child nodes of the root node. The subgraph or tree representation of a hierarchically related subset of the set of resources may include many hierarchical levels, each including multiple nodes corresponding to many different types of resources.

The references or relationships are each encoded as one or more property/value pairs. A higher-level node may include a property/value pair that serves as a reference to a lower-level node or the lower-level mode may include a property/value pair that serves as a reference to a higher-level node. A value in a property/value pair that serves as a reference may be a cloud-provider provided resource identifier, but other types of values may serve as references. In certain implementations, it is convenient to consider a reference to be a multi-field entity, such as a set of colon-separated fields, that specifies a cloud provider, a service offered by the cloud provider, a resource type, and one or more properties that form a path to a particular property/value pair containing the value that specifies a resource object: “CP: service: type: property: . . . :property/value.” However, other types of encodings can be used for resource-object references in alternative implementations.

FIG. 24 illustrates the second step in processing a set of SLS data files for representation as a graph by the currently disclosed GBUI. Resource objects 2402 are successively input to, and considered by, the second step of processing. Each received resource object is added to a set of resource objects 2404 accumulated during the second step of processing. The resource objects are indexed by one or more indices 2406 that are generated during the processing of the resource object. In addition, the resource objects are added to nascent subgraphs, such as subgraphs 2408-2409, when they reference or are referenced by resource objects that have already been added to the nascent subgraphs, or otherwise, when they contain potential references to other resource objects, become root nodes of new graphs. In one implementation, one of the indexes used to index the received resource objects, such as index 2406, indexes resource objects by resource ID. After a threshold number of resource objects have been processed, the collected resource objects, indices, and nascent subgraphs are packaged together into a capsule 2412 which is forwarded to a third processing step. Thus, the second processing step, or aggregation step, converts a number of resource objects extracted from a set of SLS data files into a set of capsules.

FIG. 25 illustrates the third step in processing a set of SLS data files for representation as a graph by the currently disclosed GBUI. The third step receives successive capsules 2502 and adds information extracted from the capsules to a growing set of stored information, including resource objects, subgraphs, and indices, that together contain the information needed to represent cloud infrastructure specified by a set of SLS data files as a graph. In a described implementation, a list of root-node pointers 2504 is maintained to reference the subgraphs 2506-2509 so far constructed from information contained in received capsules. In one implementation, the subgraphs may be represented as nodes containing resource IDs and pointers to related, lower-level nodes. In other implementations, the subgraphs may be represented by structured arrays and, in still other implementations, the subgraphs may be represented by replacing fields in stored resource objects with encoded references to other resource objects. The stored information additionally contains a list or array of resource objects 2512. In one implementation, these resource objects are indexed by resource ID 2514. In addition, fields within resource objects that contain potential references to other resource objects may be indexed by another index 2516 which indexes such fields by the encoded references corresponding to the fields 2518. In one implementation, each resource object is additionally paired with a list of subgraph nodes which reference the resource object, such as the list of subgraph nodes 2522 associated with resource object 2522. The currently disclosed implementation also maintains an index that indexes terms corresponding to categories, such as resource types, to terms or phrases that represent particular instances of the categories 2524. This is useful for providing, by the GBUI, auto-completion functionality to users typing in text specifying searches, discussed further below.

FIG. 26 illustrates various different ways a resource object extracted from a capsule can be added to the information stored by the GBUI for representation of the information contained in a set of SLS data files by a graph. The capsule 2602 may contain a new set of resource object 2604 that together comprise a new subgraph 2606, with the new resource objects added to the stored resource objects 2608 and a reference to the root node of the new subgraph added to the list of references to subgraphs 2610. Alternatively, a new resource object 2612 extracted from the capsule may be referenced by a previously received resource object represented by a node 2614 of a nascent subgraph 2616. Therefore, in addition to adding the new resource object 2612 to the stored resource object 2608, a node corresponding to the new resource object 2618 is added to the subgraph 2616. A newly received object 2620 may include fields that are potential references to other resource objects, in which case those fields are indexed by the unresolved-potential-references index 2622. The resource-ID index 2624 is updated to reference the newly received resource objects added to the list or array of stored resource objects. In addition, the term index may be updated to reference new instances of categories contained in the newly received resource objects. These are but a small set of examples of the various types of stored-information updates carried out when capsules are received and processed in the third processing step, including updating of various additional types of indexes and maps.

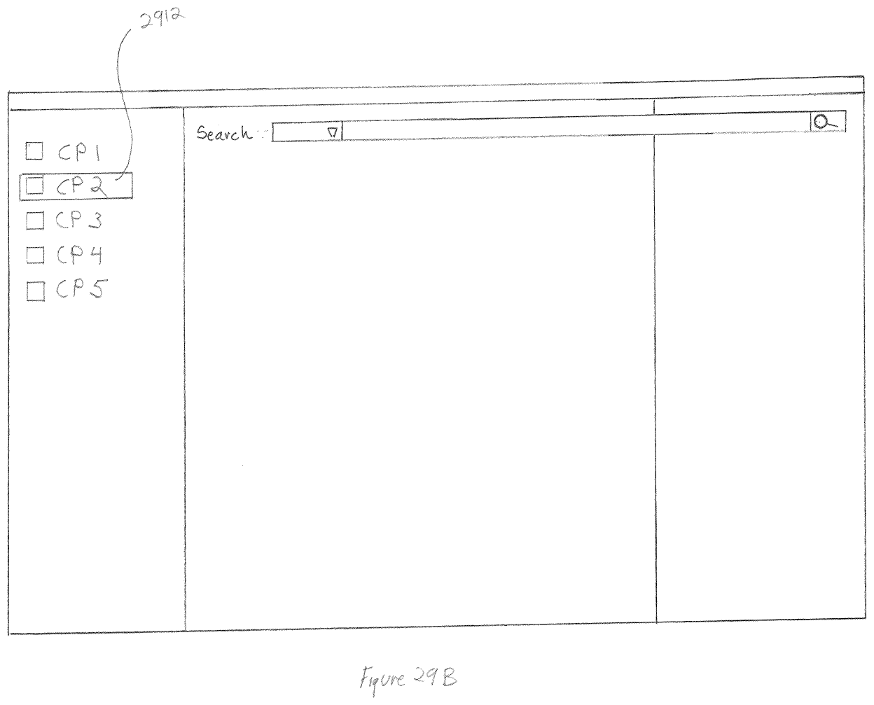

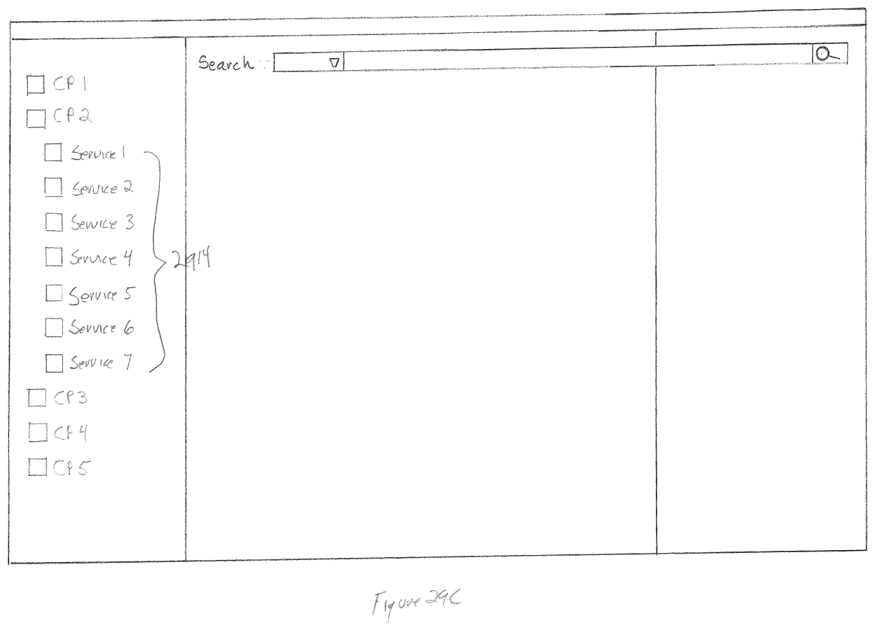

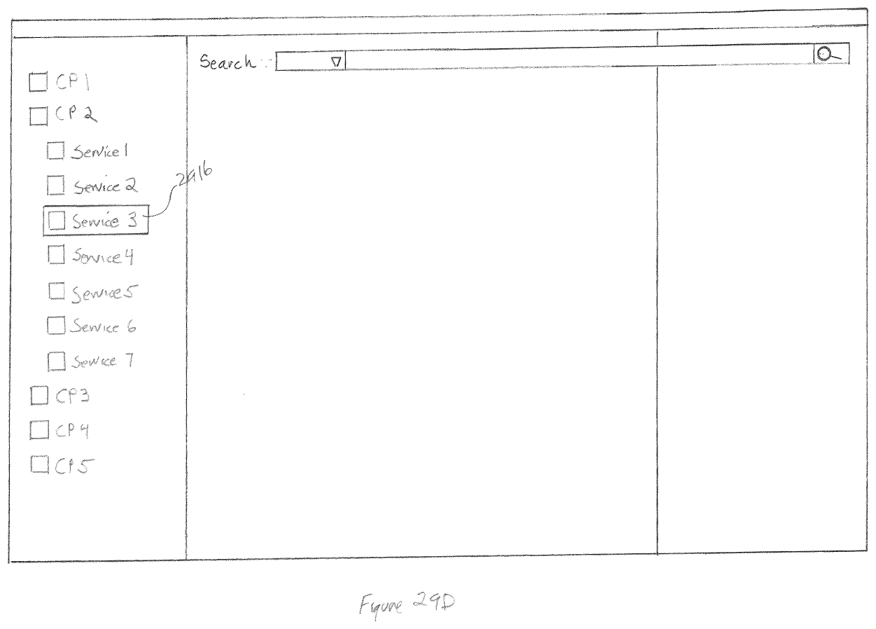

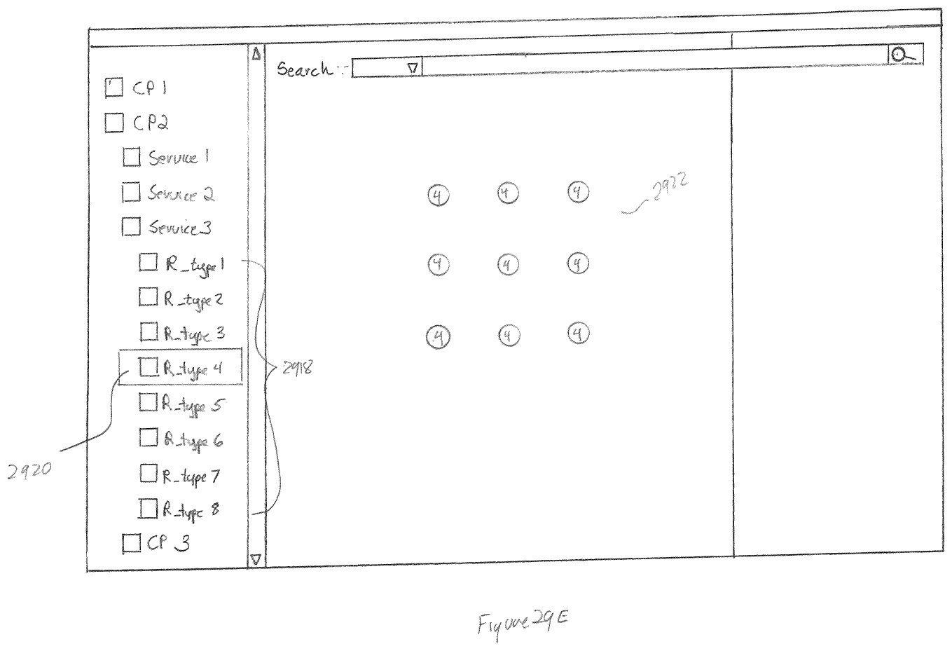

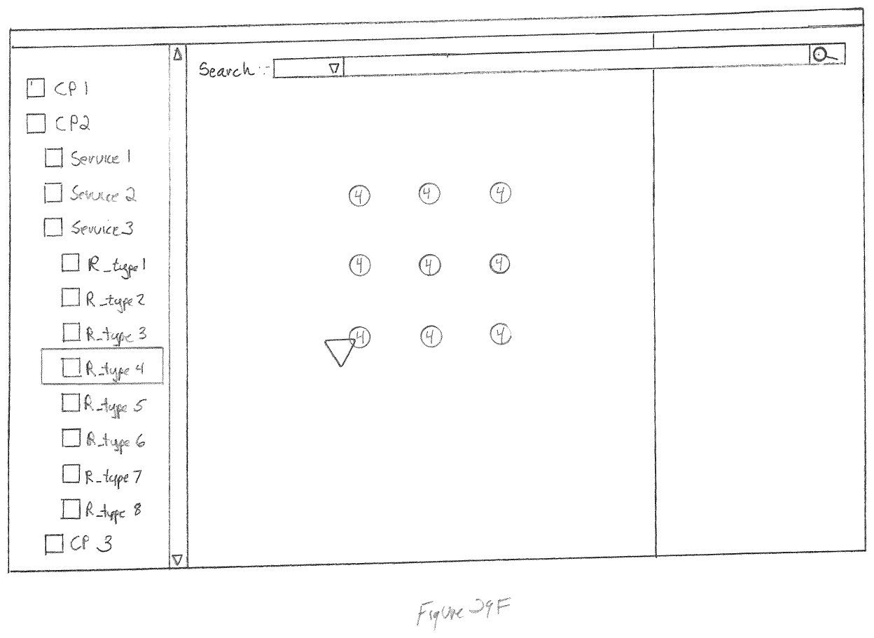

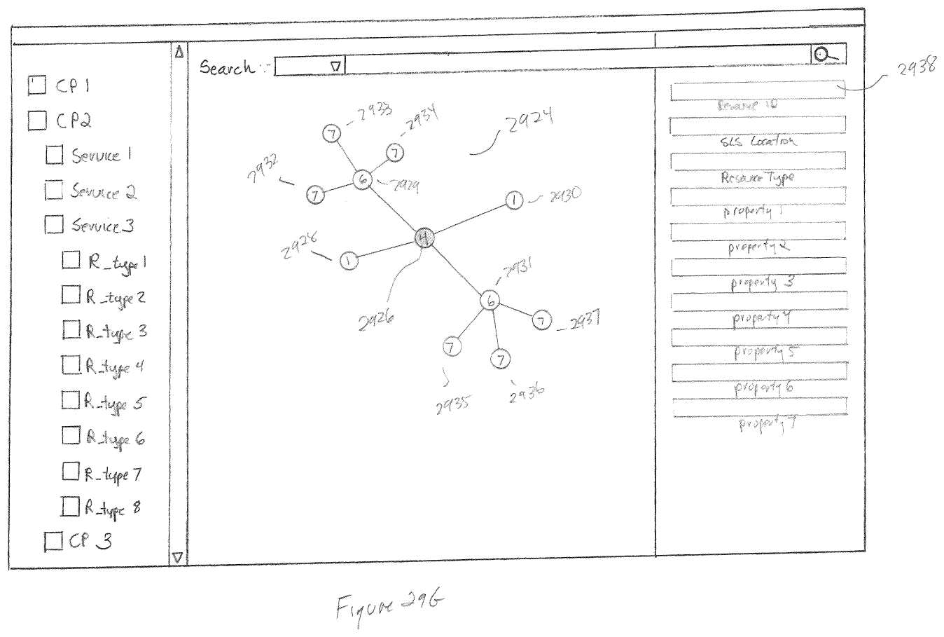

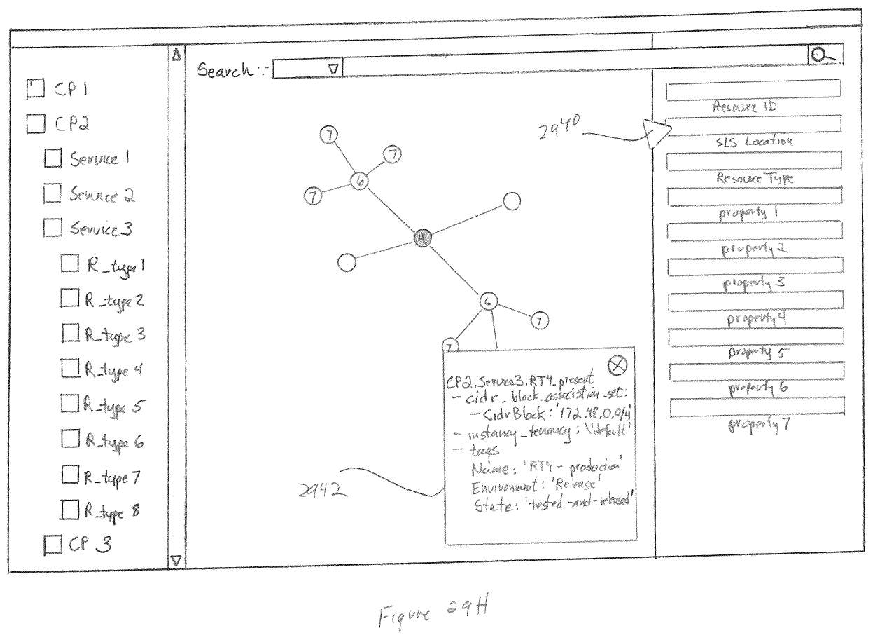

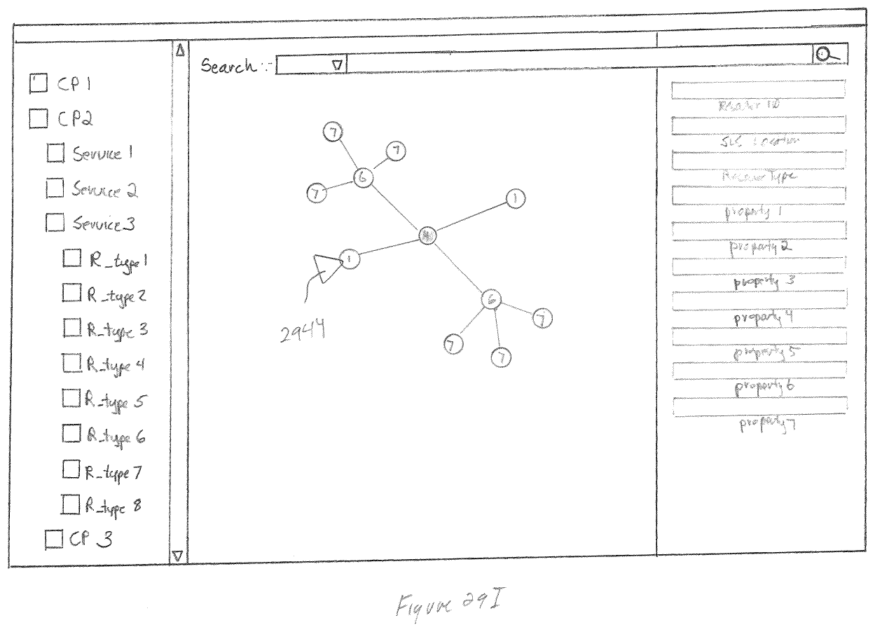

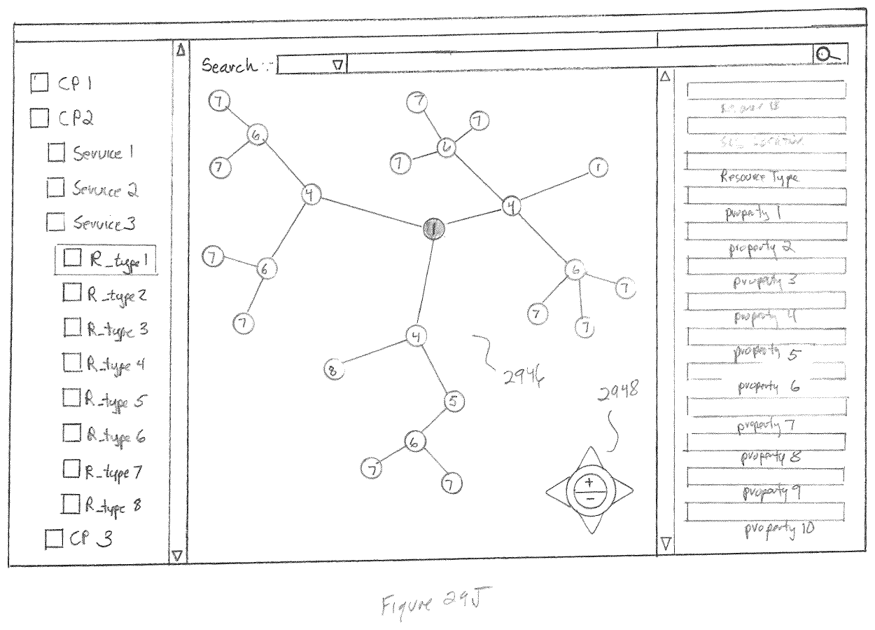

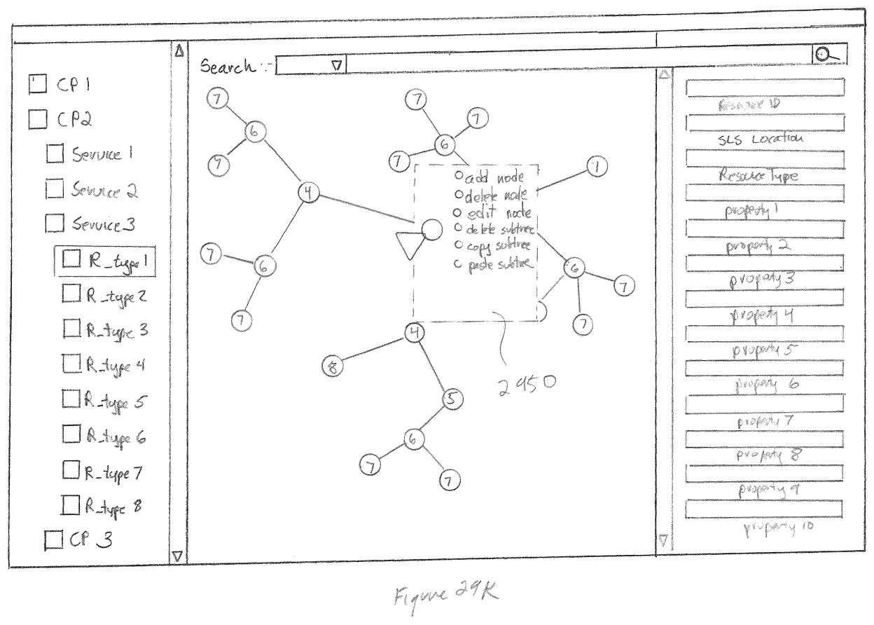

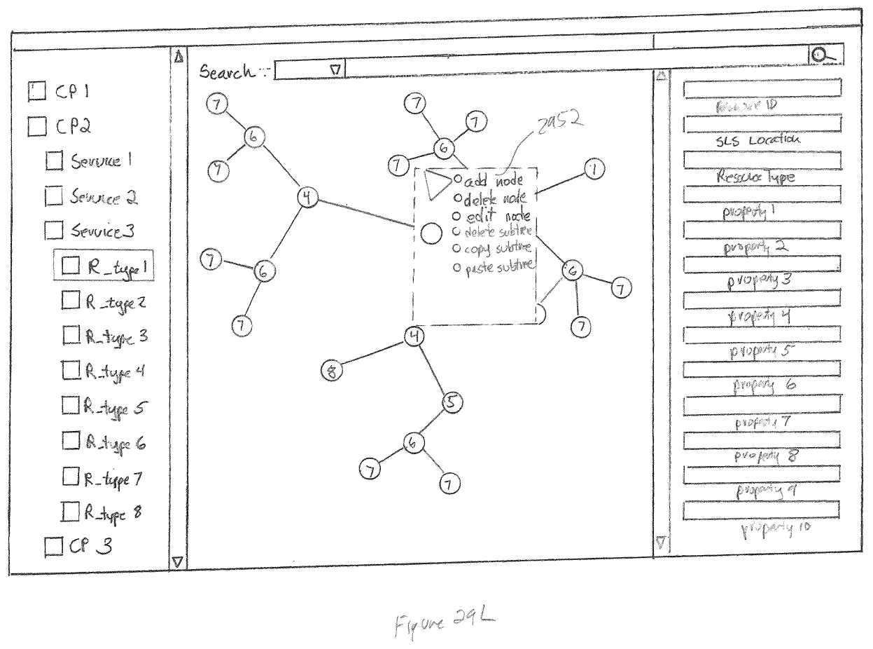

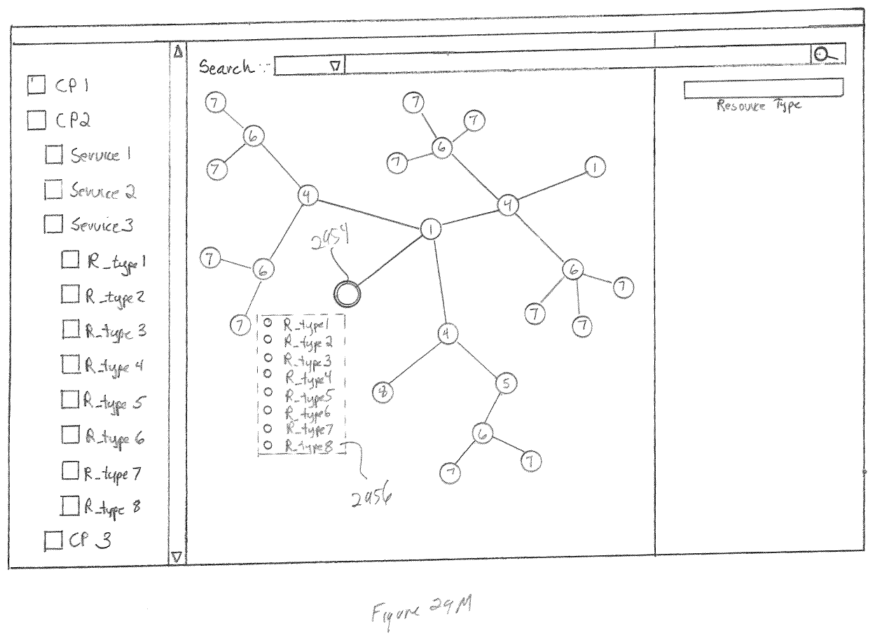

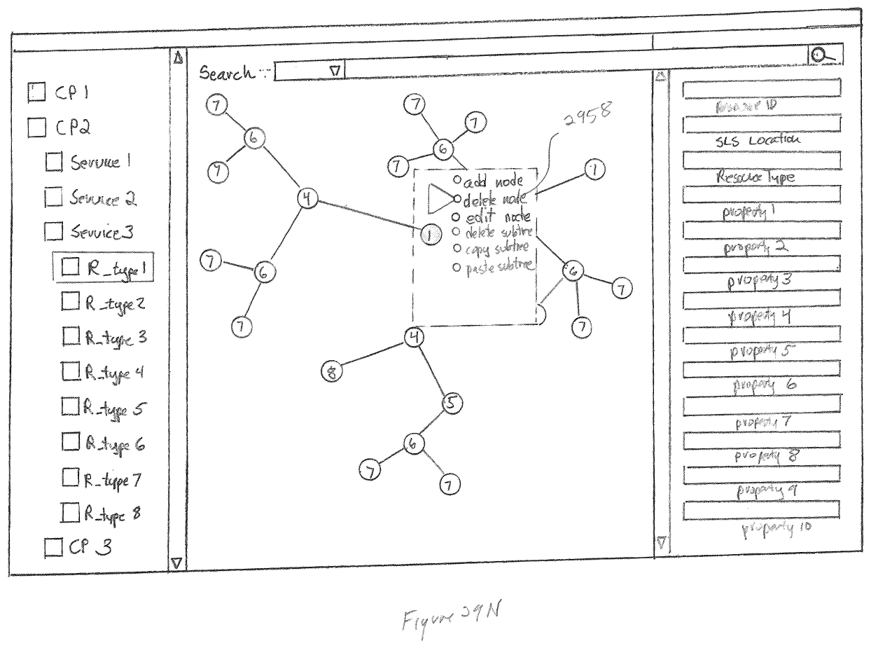

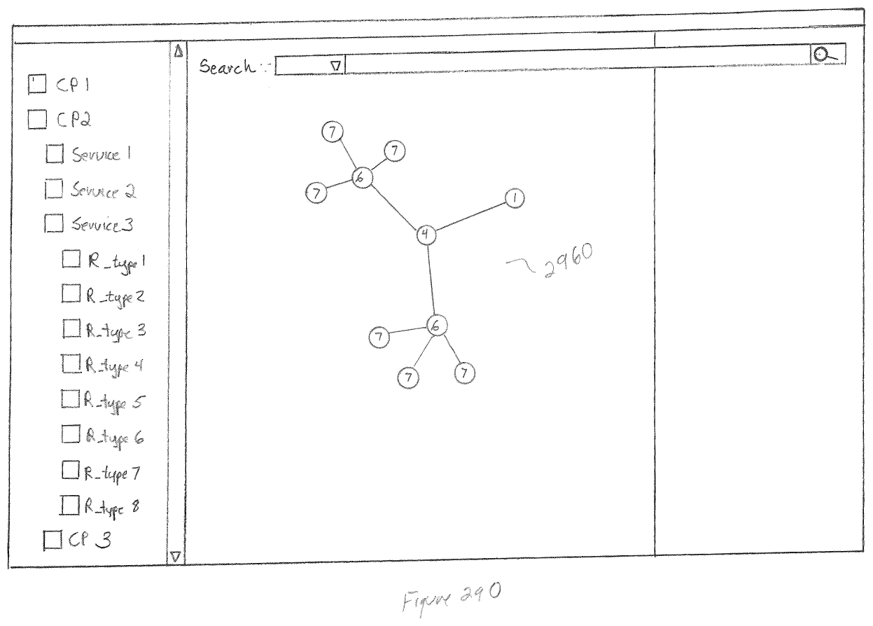

FIG. 27 illustrates graph compaction. At regular intervals, the current set of subgraphs may be processed in order to combine subgraphs into larger subgraphs. For example, shown in FIG. 27, a particular resource object 2702 may be associated with a list of nodes that reference the resource object 2704 containing two different nodes in two different subgraphs. This indicates that the two different subgraphs 2706 and 2708 both contain nodes, nodes 2710 and 2711, respectively, corresponding to the resource object 2702. As a result, the two subgraphs 2706 and 2708 may be combined to generate a larger subgraph 2714 containing only a single node 2716 corresponding to the resource object 2702. Graph compaction may be repeatedly carried out at various intervals during capsule processing and each graph compaction may involve multiple iterations.

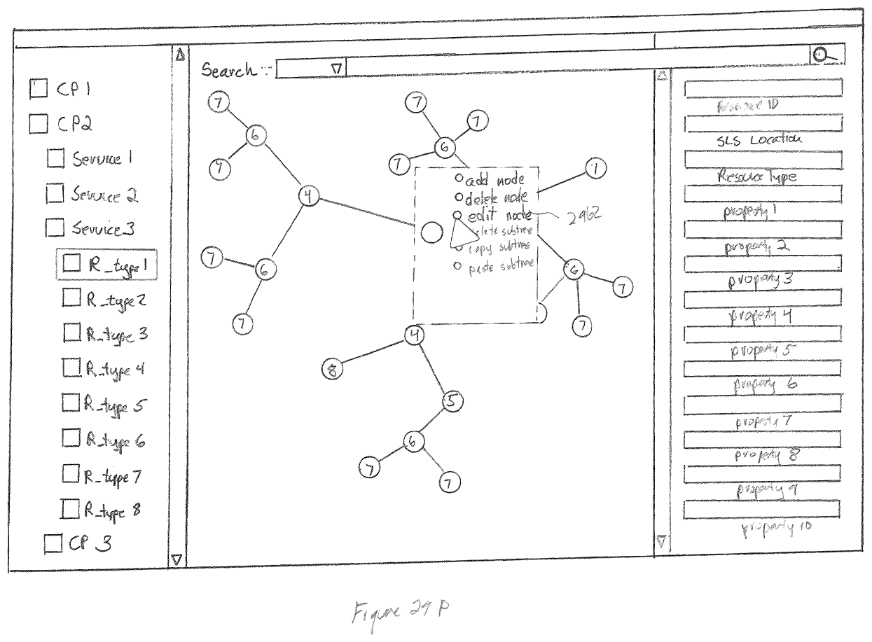

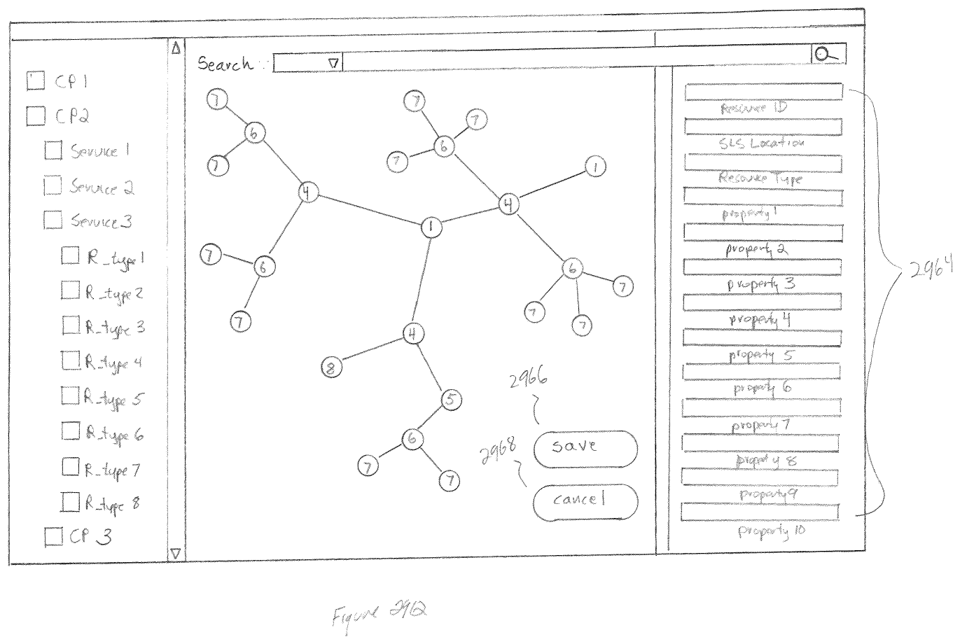

FIG. 28 illustrates the architecture of one implementation of the GBUI. The GBUI 2802 receives a set of SLS data files 2804 organized within a file directory. Thus, the location of any particular resource specification in the set of SLS data files can be specified by a directory path and a reference to the resource specification within the SLS data file specified by the directory path. An SLS-data-ingestor component 2806 processes the SLS data files to generate resource objects 2808-2810, as discussed above with reference to FIG. 22. A set of aggregator components 2812-2814 execute in parallel to together compose a capsulator component 2816 that generates capsules from the resource objects produced by the SLS-data-ingestor component 2806, as discussed above with reference to FIGS. 23-24. An entity-service component 2820 receives the capsules and carries out the third processing step discussed above with reference to FIGS. 25-26. The entity-service component periodically invokes execution of a compactor component 2822 to combine subgraphs into larger subgraphs, as discussed above with reference to FIG. 27. The in-memory SLS ledger 2824 represents the stored information maintained by the entity service, such as the various indices and references to resource objects (2520 in FIG. 25) that allow for subgraphs combination by the compactor 2822. Once the set of SLS data files are processed, the entity-service component 2020 produces a stored graphical representation of the information contained in the SLS data files 2826 and a lexer component 2828 and inverted index 2830 based on the term index (2524 in FIG. 25) that together provide the stored information used by a request-processor component 2832 of the GBUI that controls, and provides information to, the graph-based user interface 2834.

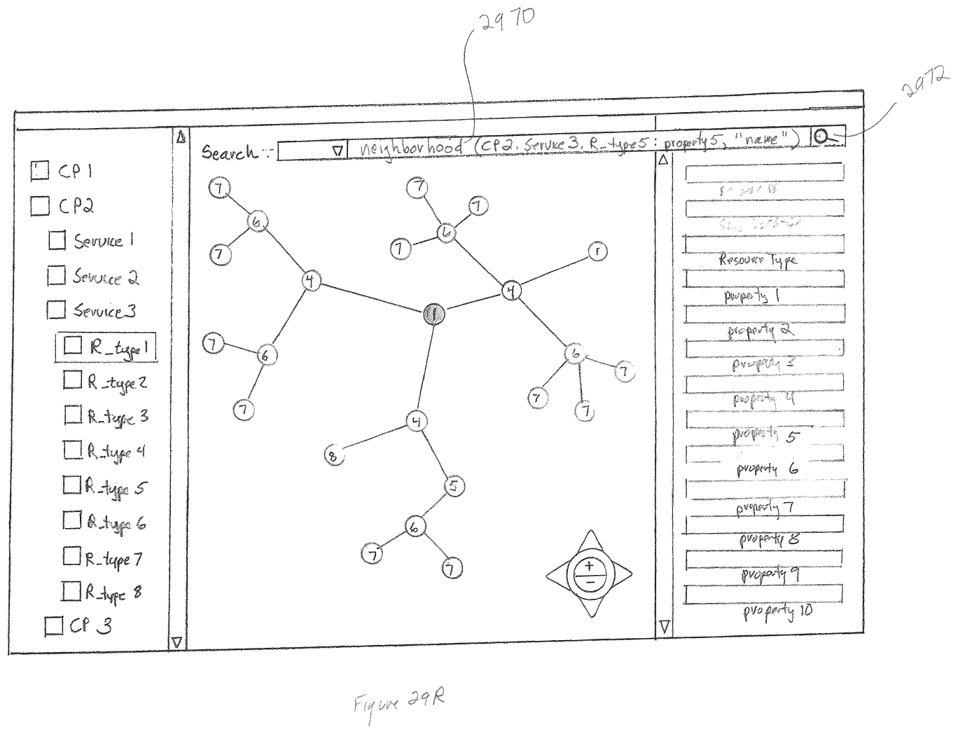

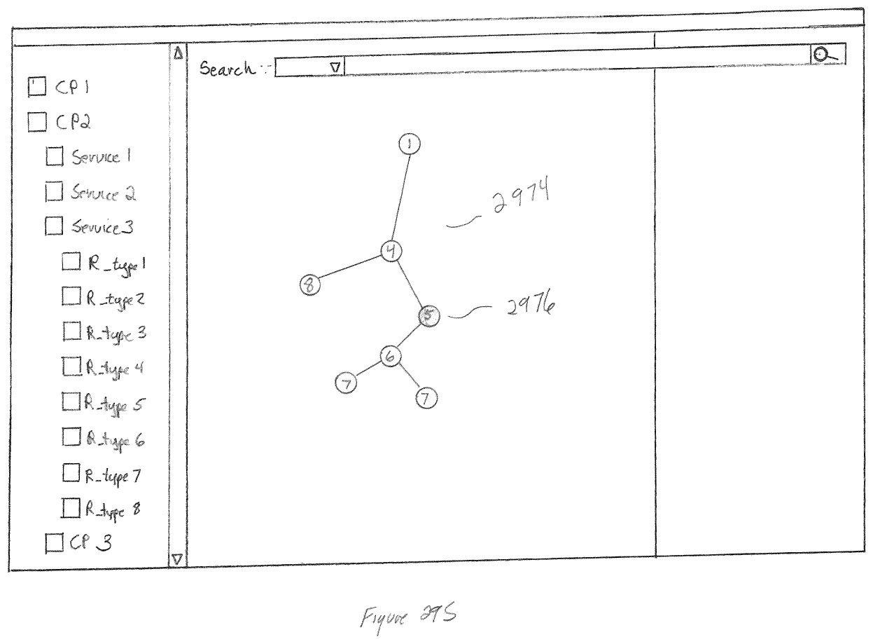

FIGS. 29A-S illustrate operation of one implementation of the currently disclosed GBUI. The GBUI 2902 includes a resource-subset-selector panel 2904, a graph-display panel 2906, a resource-detail-display panel 2908, and a search-text window 2910. The resource-subset-selector panel 2904 allows a user to quickly select a resource subset based on a cloud provider, service, and resource type. The graph-display panel 2906 displays portions of the graph that represents the information contained in a set of SLS data files. The resource-detail-display panel 2908 displays the information contained within a selected resource object, including the resource ID, location within the set of SLS data files, resource type, and the various property/value pairs that contain information about the resource. The search-text window 2910 provides a text-entry window into which a user can type a textual search query.

As shown in FIG. 29B, a user inputs a mouse click or other input to select a particular cloud provider 2912 displayed in the resource-subset-selector panel, which results in expansion of the entry of the cloud provider, as shown in FIG. 29C, to display the various services provided by the cloud provider 2914. As shown in FIG. 29D, the user inputs a mouse click or other input to select a particular service 2916 from among the services provided by the previously selected cloud provider, which results in expansion of the entry for the service, as shown in FIG. 29E, to show the various different resource types associated with the service 2918. Selection by a user of a particular resource type 2920 results in display, in the graph-display panel, of graph nodes 2922 of the selected resource type. Selection of a particular graph node of the selected resource type, as shown in FIG. 29F, results in display, in the graph-display panel, of a portion of the graph that represents information contained in the set of specification-and-configuration data files that includes the selected graph node along with a display of the information contained in the resource object corresponding to the selected graph node in the resource-detail-display panel, as shown in FIG. 29G. The subgraph 2924 displayed in the graph-display panel contains the selected node 2926 along with lower-level related nodes 2928-2931 and additional lower-level nodes related to them 2932-2937. The various text-display windows, such as text-display window 2938, in the resource-detail-display panel display alphanumeric representations of the values stored in various fields of the resource object corresponding to the selected node 2926. When, as shown in FIG. 29H, a user selects the SLS-location text-display window 2940, the representation 2942 of the selected node in the SLS data file containing the SLS specification of the resource is displayed to the user. The GBUI provides text-editing functionality to allow the user to directly edit the SLS data file, in many implementations. As shown in FIG. 29I, when the user inputs a mouse click or other input 2944 to another node in the displayed subgraph, the GBUI, shown in FIG. 29J, displays a subgraph 2946 centered around the selected node. Thus, a user can navigate through the graph representation of the SLS data by selecting nodes. In addition, the GBUI, in many implementations, provides graph-navigation tools 2948 that allow the user to zoom into and out from the current display level and pan the graph-display window over the graph in order to view different portions of the graph.

When the user inputs an edit-mode selection to a graph node, as illustrated in FIG. 29K, the GBUI displays a selectable list of editing options 2950. When the user selects an add-node editing option 2952, as shown in FIG. 29L, the GBUI adds a new node 2954 to the graph, as shown in FIG. 29M, and additionally displays a list of selectable resource types 2956. When the user selects a resource type for the new node, the GBUI then displays text-entry windows for various additional fields of a new resource object corresponding to the new node in the resource-detail-display panel, allowing the user to specify property values and other information for the new node. Of course, a specification for the new node, including the specified property values and other information, is added to the SLS data files by the GBUI. When, by contrast, the user selects a delete-node editing option 2958, as shown in FIG. 29N, the GBUI deletes the selected node and all lower-level nodes connected to the selected node from the graph and displays those portions of the previously displayed subgraph following the deletion operation 2960, as shown in FIG. 29O. When the user selects an edit-node editing option 2962, as shown in FIG. 29P, the GBUI displays text-entry windows 2964 in the resource-detail-display panel, that allows the user to edit the property values and other values in the resource object corresponding to the currently selected node and provides save 2966 and cancel 2968 options for storing or ignoring the modifications made to the resource object. Any modifications that are saved are propagated to the SLS data files. Finally, as shown in FIG. 29R, a user can input a query 2970 into the search-text window and a mouse click or other input to a search feature 2972 in order to search for a particular resource. As shown in FIG. 29S, when a search is successful, the GBUI displays a subgraph 2974 containing the specified resource 2976.

The present invention has been described in terms of particular embodiments, it is not intended that the invention be limited to these embodiments. Modifications within the spirit of the invention will be apparent to those skilled in the art. For example, any of many different implementations of the currently disclosed methods and systems can be obtained by varying various design and implementation parameters, including modular organization, control structures, data structures, hardware, operating system, and virtualization layers, automated orchestration systems, virtualization-aggregation systems, and other such design and implementation parameters. The GBUI may include many different display panels and features, in addition to those shown in FIGS. 29A-S and discussed above. Many different types of graph displays may be used, including various types of color coding and two-dimensional and three-dimensional graph representations.

What is claimed is:

1. An automated cloud-infrastructure manager comprising:
one or more computer systems, each containing one or more processors, one or more memories, one or more data-storage devices, and one or more display devices;
a set of cloud-infrastructure specification-and-configuration data files stored in one or more of the one or more memories and one or more data-storage devices; and
processor instructions, stored in one or more of the one or more memories that, when executed by one or more of the one or more processors, control the one or more computer systems to implement the automated cloud-infrastructure manager, the automated cloud-infrastructure manager comprising
a management interface that receives cloud-infrastructure-management commands and requests, including idempotent state commands that deploy and configure cloud infrastructure according to the set of cloud-infrastructure specification-and-configuration data files,
an execution engine that executes the received cloud-infrastructure-management commands and requests, and
a graph-based user interface that displays, on one or more of the one or more display devices, a graph-based visual representation of cloud-infrastructure information contained in the set of cloud-infrastructure specification-and-configuration data files.

2. The automated cloud-infrastructure manager of claim 1 wherein graph-based visual representation of cloud-infrastructure information contained in the set of cloud-infrastructure specification-and-configuration data files is generated by:
receiving the set of cloud-infrastructure specification-and-configuration data files;
extracting resource objects from the cloud-infrastructure specification-and-configuration data files;
interactively processing a next set of resource objects from the extracted resource objects to generate a next unit of graph information until the extracted resource objects have been processed; and
incorporating each unit of graph information into a stored graph representation of cloud-infrastructure information contained in the set of cloud-infrastructure specification-and-configuration data files.

3. The automated cloud-infrastructure manager of claim 2 wherein each resource object corresponds to specification and configuration information for a resource contained in the set of cloud-infrastructure specification-and-configuration data files.

4. The automated cloud-infrastructure manager of claim 3 wherein a resource object includes multiple data fields, including:
a resource-ID data field;
a resource-type data field;
a file-location data field; and
one or more property/value data fields.

5. The automated cloud-infrastructure manager of claim 2 wherein interactively processing a next set of resource objects from the extracted resource objects to generate a next unit of graph information further comprises:
for each resource object in the next set of resource objects,
adding the resource object to a set of resource objects,
when an existing node of a nascent subgraph references the resource object, adding a node to the nascent subgraph corresponding to the resource object linked to the existing node of the nascent subgraph,
when resource object references an exiting node of a nascent subgraph, adding a node to the nascent subgraph corresponding to the resource object linked to the existing node of the nascent subgraph,
when the resource object contains potential references to other resource objects that are not represented by a node in a nascent subgraph, creating a new root node for a new nascent subgraph corresponding to the resource object, and
updating one or more indexes to reference one or more of
the resource object,
a field of the resource object,
a word in a field of the resource object, and
a phrase in a field of the resource object.

6. The automated cloud-infrastructure manager of claim 5 wherein incorporating each unit of graph information into a stored representation of cloud-infrastructure information contained in the set of cloud-infrastructure specification-and-configuration data files further comprises:
incorporating the set of resource objects in the unit of graph information into a stored set of resource objects within the stored representation of cloud-infrastructure information;
adding each nascent subgraph in the unit of graph information to a set of subgraphs within the stored representation of cloud-infrastructure information by one of
adding the nascent subgraph as a new subgraph in the set of subgraphs within the stored representation of cloud-infrastructure information, and
combing the nascent subgraph with a subgraph within the stored representation of cloud-infrastructure information; and
incorporating one or more indexes in the unit of graph information into corresponding one or more indexes within the stored representation of cloud-infrastructure information.

7. The automated cloud-infrastructure manager of claim 5 wherein incorporating each unit of graph information into a stored representation of cloud-infrastructure information contained in the set of cloud-infrastructure specification-and-configuration data files further comprises iteratively combining subgraphs within the stored representation of cloud-infrastructure information to generate larger subgraphs within the stored representation of cloud-infrastructure information.

8. The automated cloud-infrastructure manager of claim 2
wherein the graph-based user interface displays a graph-based visual representation of cloud-infrastructure information contained in the set of cloud-infrastructure specification-and-configuration data files by displaying, in a graph-display panel, portions of a graph, comprising one or more subgraphs, contained in the stored representation of cloud-infrastructure information; and
wherein the graph-based user interface provides navigation tools that allow for changing the displayed portion of the graph in the graph-display panel.

9. The automated cloud-infrastructure manager of claim 2 wherein the graph-based user interface displays, in a resource-detail-display panel, textual renderings of the contents of one or more fields in a resource object corresponding to a selected node in a portion of the graph displayed in the graph-display panel.

10. The automated cloud-infrastructure manager of claim 2
wherein the graph-based user interface provides an editing mode in which the graph and the resource objects corresponding to nodes and edges in the graph are modified; and
wherein modifications made to resource objects corresponding to nodes and edges in the graph are propagated to the specification-and-configuration data files.

11. The automated cloud-infrastructure manager of claim 2 wherein, when the graph-based user interface is in editing mode, the graph and the resource objects corresponding to nodes and edges in the graph are modified by:
adding one or more nodes and corresponding resource objects to the graph;
deleting one or more nodes and corresponding resource objects from the graph;
changing the information contained in one or more fields of one or more resource objects;
adding a subgraph to the graph; and
deleting a subgraph from the graph.

12. The automated cloud-infrastructure manager of claim 2 wherein the graph-based user interface provides a resource-subset-selector panel which selects subsets of resources corresponding to one of:
an indicated cloud provider;
an indicated service provided by an indicated cloud provider; and
a resource type of an indicated service provided by an indicated cloud provider.

13. The automated cloud-infrastructure manager of claim 2
wherein the graph-based user interface includes a search-text window which receives textual search requests for particular resources and types of resources; and
wherein the graph-based user interface provides autocompletion functionality for text entry into the search-text window using one or more indexes generated during processing of the set of specification-and-configuration data files.

14. A method that provides a visual, graph-based interface to an automated cloud-infrastructure manager, the method comprising:
processing a set of cloud-infrastructure specification-and-configuration data files to extract resource objects from the cloud-infrastructure specification-and-configuration data files;
interactively processing a next set of resource objects from the extracted resource objects to generate a next unit of graph information until the extracted resource objects have been processed;
incorporating each unit of graph information into a stored representation of cloud-infrastructure information contained in the set of cloud-infrastructure specification-and-configuration data files; and
using the stored representation of cloud-infrastructure information contained in the set of cloud-infrastructure specification-and-configuration data files to provide a graph-based user interface that displays a graph-based representation if the information contained in the set of cloud-infrastructure specification-and-configuration data files and that provides visual and textual editing functionalities.

15. The method of claim 14
wherein the automated cloud-infrastructure manager comprises
one or more computer systems, each containing one or more processors, one or more memories, one or more data-storage devices, and one or more display devices, and
processor instructions, stored in one or more of the one or more memories that, when executed by one or more of the one or more processors, control the one or more computer systems to implement
a management interface that receives cloud-infrastructure-management commands and requests, including idempotent state commands that deploy and configure cloud infrastructure according to the set of cloud-infrastructure specification-and-configuration data files,
an execution engine that executes the received cloud-infrastructure-management commands and requests, and
the graph-based user interface.

16. The method of claim 14
wherein the stored representation of cloud-infrastructure information includes nodes corresponding to resource objects and edges corresponding to relations between resource objects, each relationship comprising a reference from one resource object to another resource object;
wherein the graph-based user interface displays a graph-based visual representation of cloud-infrastructure information contained in the set of cloud-infrastructure specification-and-configuration data files by displaying, in a graph-display panel, portions of a graph, comprising one or more subgraphs, contained in the stored representation of cloud-infrastructure information; and
wherein the graph-based user interface provides navigation tools that allow for changing the displayed portion of the graph in the graph-display panel.

17. The method of claim 14 wherein the graph-based user interface displays, in a resource-detail-display panel, textual renderings of the contents of one or more fields in a resource object corresponding to a selected node in a portion of the graph displayed in the graph-display panel.

18. The method of claim 14
wherein the graph-based user interface provides an editing mode in which the graph and the resource objects corresponding to nodes and edges in the graph are modified; and
wherein modifications made to resource objects corresponding to nodes and edges in the graph are propagated to the specification-and-configuration data files.

19. The method of claim 14
wherein, when the graph-based user interface is in editing mode, the graph and the resource objects corresponding to nodes and edges in the graph are modified by
adding one or more nodes and corresponding resource objects to the graph,
deleting one or more nodes and corresponding resource objects from the graph,
changing the information contained in one or more fields of one or more resource objects,
adding a subgraph to the graph, and
deleting a subgraph from the graph.

20. The method of claim 14
wherein the graph-based user interface provides a resource-subset-selector panel which selects subsets of resources corresponding to one of:
an indicated cloud provider;
an indicated service provided by an indicated cloud provider; and
a resource type of an indicated service provided by an indicated cloud provider.

21. The automated cloud-infrastructure manager of claim 14
wherein the graph-based user interface includes a search-text window which receives textual search requests for particular resources and types of resources; and
wherein the graph-based user interface provides autocompletion functionality for text entry into the search-text window using one or more indexes generated during processing of the set of specification-and-configuration data files.

22. A physical data-storage device encoded with processor instructions that, when executed by one or more processors within one or more computer systems, each containing one or more processors, one or more memories, and one or more data-storage devices, control the one or more computer systems to implement an automated cloud-infrastructure manager that provides a visual, graph-based interface to an automated cloud-infrastructure manager by:
processing a set of cloud-infrastructure specification-and-configuration data files to extract resource objects from the cloud-infrastructure specification-and-configuration data files;
interactively processing a next set of resource objects from the extracted resource objects to generate a next unit of graph information until the extracted resource objects have been processed;
incorporating each unit of graph information into a stored representation of cloud-infrastructure information contained in the set of cloud-infrastructure specification-and-configuration data files; and
using the stored representation of cloud-infrastructure information contained in the set of cloud-infrastructure specification-and-configuration data files to provide a graph-based user interface that displays a graph-based representation if the information contained in the set of cloud-infrastructure specification-and-configuration data files and that provides visual and textual editing functionalities.
